(19) United States
(12) Patent Application Publication
(10) Pub. No.: US 2013/0046584 A1
(43) Pub. Date: Feb. 21, 2013

(54) PAGE REPORTING

(71) Applicants: Jimmy YU, Foster City, CA (US); Lemuel S. PARK, Cerritos, CA (US); Lennon LIAO, San Mateo, CA (US); Sammy YU, San Mateo, CA (US)

(72) Inventors: Jimmy YU, Foster City, CA (US); Lemuel S. PARK, Cerritos, CA (US); Lennon LIAO, San Mateo, CA (US); Sammy YU, San Mateo, CA (US)

(73) Assignee: BRIGHTEDGE TECHNOLOGIES, INC., San Mateo, CA (US)

(21) Appl. No.: 13/587,455

(22) Filed: Aug. 16, 2012

Related U.S. Application Data
(60) Provisional application No. 61/524,253, filed on Aug. 16, 2011.

(51) Int. Cl. G06F 17/30; G06Q 10/00

(52) U.S. Cl. 705/7.38; 707/723; 707/E17.005

(57) ABSTRACT

A method for optimizing search results for an entity includes categorizing a plurality of web pages into a plurality of page types. The method may also include performing a search of a network in order to obtain business performance data for each of the page types. Thereafter, business performance data may be analyzed to determine how to optimize the performance of a particular page type. Page based recommendations may be provided based on web analytics data and may be integrated with content management systems to enable a user to directly modify a web page or template to improve search engine ranking

### CROSS-REFERENCE TO RELATED APPLICATION

This patent application claims the benefit of U.S. Provisional Patent Application No. 61/524,253, filed Aug. 16, 2011, which is incorporated herein by reference.

### BACKGROUND

The Internet has changed the way people gather information, establish relationships with one another and even how people communicate with one another.

Additionally, the Internet has changed the way companies seek potential customers and even what the meaning of a business is. It has changed the way companies advertise, sell, coordinate with one another and compete with one another. With this change has come a huge explosion in the number of web pages for people to visit. Search engines, such as Google, Bing, Yahoo and others have come into being to help people find their way to web pages that they desire. As a result, the number and types of channels that a marketer can leverage has also exploded—beyond organic and paid search, they can also leverage blogs, social media, video sharing, mobile content, ads, display ads, and many other channels.

Additionally, tracking the behavior of the actions of each visitor would allow the web page to be marketed more efficiently. In particular, many web pages track their organic search performance in search engines based on number of visits for certain keywords. However, they cannot determine how many visitors came as a result of a particular search engine result and rank position to the web page, instead they must estimate this based on the data (referral header) passed to the web page which only helps them determine the number of visitors that came from a specific keyword. Without understanding key attributes of their performance on the search engine, they cannot accurately determine the effectiveness of their marketing efforts.

Accordingly, a web page owner might be confronted with limited marketing budgets that allow them to either improve their ranking in search engine results or that will place advertisements for their web page on other web pages but not both. Currently, the web page owner must choose which strategy to follow with limited information on which would be more effective.

For large websites, managing content, external references (e.g., links from third parties) and other relevant data has always been a challenge because of the scale. Consequently as a result of scale, the sheer number of web pages for large websites makes it impractical to apply traditional marketing analysis to apply opportunity, forecasting or even basic performance monitoring/reporting for millions of pages and millions of unique keywords associated with actions related to the entity.

Due to the issues involved with scale, marketers have no granularity in data analysis behind the measuring and management of large sites at scale for SEO. For example, sites typically only measure the number of total web pages they have indexed by search engines as a single performance metric. The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter.

A method for optimizing search results for an entity includes categorizing a plurality of web pages into a plurality of page types. The method may also include performing a search of a network in order to obtain business performance data for each of the page types. Thereafter, business performance data may be analyzed to determine how to optimize the performance of a particular page type.

These and other objects and features of the present invention will become more fully apparent from the following description and appended claims, or may be learned by the practice of the invention as set forth hereinafter.

### BRIEF DESCRIPTION OF THE DRAWINGS

To further clarify various aspects of some example embodiments of the present invention, a more particular description of the invention will be rendered by reference to specific embodiments thereof which are illustrated in the appended drawings. It is appreciated that these drawings depict only illustrated embodiments of the invention and are therefore not to be considered limiting of its scope. The invention will be described and explained with additional specificity and detail through the use of the accompanying drawings in which:

FIG. 1 illustrates a block diagram of a system for optimizing search engine results for a type of pages;

FIG. 2 is a flow diagram illustrating a method of optimizing search engine results for a type of pages;

FIGS. 3-6 illustrate performance reporting for all of the pages of an entity;

FIGS. 7-8 illustrate performance reporting which may result for a particular page type;

FIGS. 9-14 illustrate various user interfaces which may be used to enable an entity to manually create a page type;

FIGS. 15-28 illustrate various user interfaces which may be used to enable an entity to view analytics and recommendations related to web pages and to update webpages based on the recommendations through integration with content management systems; and

FIG. 29 is a flow diagram illustrating a method of providing page recommendations.

### DETAILED DESCRIPTION

Methods and systems are provided herein for optimizing performance of a category of web pages of an entity with respect to a number of channels. These channels may include, without limitation, all organic web channels including organic searches, organic links, paid links, page searches, linked advertisement networks, banner advertisements, contextual advertisements, e-mail, blogs, social networks, social news, affiliate marketing, mobile advertisements, media advertisements, video advertisements, videos, images, discussion forums, paid advertisements, display advertisements, news sites, rich media, social bookmarks, paid searches, wiki, mobile content, and in-game advertisements. For ease of reference, search engine results will be described herein, though it will be appreciated that the discussion may be equally applicable to the channels described above.

As described herein a page represents a specific web page URL associated with the entity. A page type corresponds to a way to categorize various pages. Examples of page types for an entity who is a clothing retailer could be “Woman's Apparel” or “Baby Clothing,” such that specific web pages related to baby clothing would be categorized under the “Baby Clothing” page type. Another way to categorize various pages is to assign them to a page type according to a specific layout or template which is used to generate the specific web pages. Pages may also be added according to a series of definitions such as regular expression rules such as Boolean expressions including “starts with,” “ends with,” “contains,” does not start,” “does not end,” and “does not contain.” Using these definitions, the system may identify and automatically create groups of web pages.

Searches may be performed to index references to the entity within one or more of the channels. Based on the page types of the search results, the entity can then determine how a page type is performing on various channels, which may include search engines. This performance analysis may be in addition to the total number of web pages the entity has indexed on various search engines. In the case of analyzing performance for a particular page type, a change in actions related to the page type can be more readily understood since changes can be isolated to the page type rather than being accredited to the entire entity. Such an approach can provide a useful degree of granularity since each page type represents a meaningful category of data. Further, such an approach can help surface how categories are trending as well as help identify categories for investigation.

Reference will now be made to the figures wherein like structures will be provided with like reference designations. It is understood that the figures are diagrammatic and schematic representations of some embodiments of the invention, and are not limiting of the present invention, nor are they necessarily drawn to scale.

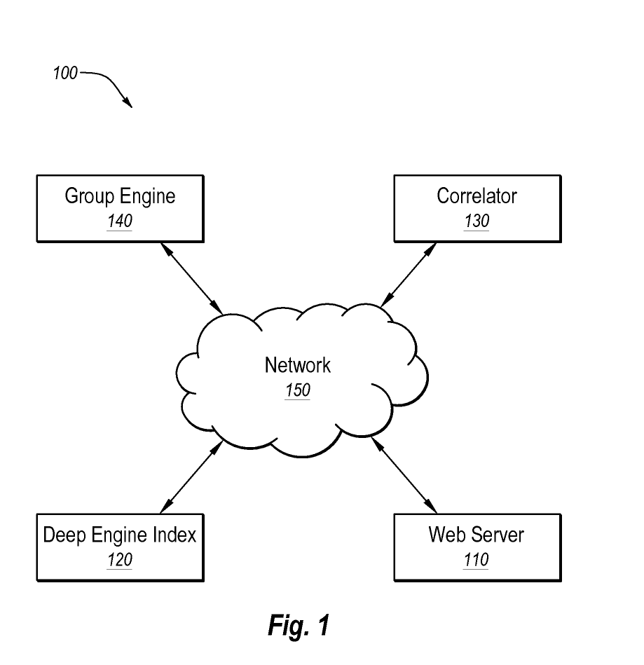

FIG. 1 illustrates a block diagram of a system 100 for optimizing search engine references for a particular category or page type of web pages of an entity. The entities whose web pages are indexed can include individuals, corporations, brands, products, models or any other entities referenced anywhere on a network such as the Internet. In particular, the system 100 can be used to identify, collect, and analyze meaningful references to a page type of an entity, such as common keywords, subject matter, templates and the like. These page types can include, without limitation, common keywords, products, page layouts or templates that are defined by a user, or other associations that are automatically generated by the system 100 based on one or more parameters, and/or some combination of the two. The page types can include, without limitation, keyword variants and related templates as identified by users of the system.

In addition or alternatively, the page types may be determined by a sample (sampling) of a more comprehensive set of aggregated keywords or pages as a method for performance reporting, measurement, and forecasting against the greater set. For example, an entity may be an e-commerce site may want to know how well the entity is ranking or performing within the “BOOKS” category. The product catalog of such an entity may contain over a million different books. Instead of tracking all 1M+ keywords and all the variations for the entity's “BOOKS” category, the entity may choose to create a page type of 10,000 web pages that serves as a sampling or (representative set) used to measure/estimate true performing/forecasting/etc. for the entire “BOOKS” category. The same can be applied to page types. In another example, an entity may be a large social website that contains millions of unique individual user profile pages. Instead of measuring all the user profile pages, the entity may choose to create a page type that consists of a representative sample of all user profile pages.

FIG. 1 shows that the system 100 can include a network 105. In at least one implementation, the network 105 can be used to connect the various parts of the system 100 to one another, such as between a web server 110, a deep index engine 120, a correlator 130, and a grouping engine 140. It will be appreciated that while these components are being shown as separate, the components may be combined as desired. Further, while one of each component is illustrated, it will be appreciated that the system 100 may include any number of each of the components shown.

As will be discussed in more detail hereinafter, the grouping engine 140 is configured to determine meaningful page types in order to provide methods, processes and platforms to manage content and relevant marketing data (SEO metrics) for the page types for large entities possessing a large amount of content and marketing data. The page types can be user defined, customized with technology intervention, or automatically generated based on intelligent analysis that combines internal/third party/external data. As a result, the system 100 is configured to perform methods for aggregating content and SEO metrics in meaningful page types that can then be tracked and measured. Analysis can be performed at these page types that will give meaningful and actionable information to the marketer due to the nature of the segmentation of the groups. Exemplary configurations and functionality of the above components will be introduced below, followed by a discussion of the operation of the system to generate the page types discussed below.

In at least one example, the network 105 includes the Internet, including a global internetwork formed by logical and physical connections between multiple wide area networks and/or local area networks and can optionally include the World Wide Web (“Web”), including a system of interlinked hypertext documents accessed via the Internet. Alternately or additionally, the network 105 includes one or more cellular RF networks and/or one or more wired and/or wireless networks such as, but not limited to, 802.xx networks, Bluetooth access points, wireless access points, IP-based networks, or the like. The network 105 can also include servers that enable one type of network to interface with another type of network.

In at least one implementation, the web server 110 (or “webserver”) can include any system capable of storing and transmitting a web page to a user. For example, the web server 110 can include a computer program that is responsible for accepting requests from clients (user agents such as web browsers), and serving them HTTP responses along with optional data contents, which can include HTML documents and linked objects for display to the user. Additionally or alternatively, the web server 110 can include the capability of logging some detailed information about client requests and server responses to log files.

The entity can include any number of web pages. The aggregation of references to the various web pages can be referred to as traffic. It should be noted that “web page” as used herein refers to any online posting, including domains, subdomains, Web posts, Uniform Resource Identifiers (“URIs”), Uniform Resource Locators (“URLs”), images, videos, or other piece of content and non-permanent postings such as e-mail and chat unless otherwise specified. The URLs may be in different formats when a user is on different devices such as a tablet, mobile kiosk, smartphone (e.g. IPHONE device or ANDROID device), personal digital assistant, etc.

In at least one implementation, external references to a web page can include any reference to the web page which directs a visitor to the web page. For example, an external reference can include text documents, such as blogs, news items, customer reviews, e-mails or any other text document which discusses the web page. Additionally or alternatively, an external reference can include a web page which includes a link to the web page. For example, an external reference can include other web pages, search engine results pages, advertisements or the like. The deep index engine 120 is configured to search the network 105 to determine how the data associated with the web pages of the page types are treated by the external references and how data associated with the page types may be applied to search results generated by search engines in particular. For example, the deep index engine 120 may be configured to search the network 105 to determine the position of the entity within search engine results when the terms associated with a particular page type was used as the basis for the search. An exemplary deep index engine is described in more detail in co-pending U.S. patent application Ser. No. 12/436,704, filed May 6, 2009, and entitled “COLLECTING AND SCORING ONLINE REFERENCES,” the disclosure of which is hereby incorporated by reference in its entirety.

In such an example, the deep index engine 120 creates, defines and/or identifies jobs using the collective terms of the page types described above. Once the deep index engine 120 creates, defines, and/or identifies jobs based on the page type, the deep index engine inserts the jobs, including, for search jobs, the assembled parameters of each search job, into a job queue.

Jobs in the job queue include, but are not limited to search jobs, e.g., crawling the Internet. In some embodiments, once the Internet has been crawled, data is obtained. In general, data refers to any information that the deep index engine has specified as relevant. In some embodiments, data can include information regarding the channels searched and the signals evaluated. In other embodiments, data can include downloading a web page for further processing or calling an API. In further embodiments, data can include search results to be parsed.

In some embodiments, once data has been obtained, it must be processed. In some embodiments, processing the data can include analyzing search engine results or analyzing API results for relevant information, such as search engine results related to the entity that are generated when the terms associated with the page types are searched. As previously introduced, these results can allow the system to determine how the entity is performing on search engines with respect to the various page types. By searching a particular page type over a period of time, a change in the number of references to an entity, as reflected by the search engine results, can be more readily understood since changes can be isolated to page types rather than to aggregate references to the entire entity. Further, these changes can be understood by understanding the relative position of other entities similar page types comprised of the web pages of the other entities are used for the basis of the search. The search engine results related to the entity may then be optimized as desired by optimizing selected page types. To this point, the selection of the page types has been introduced generally as being received from a user, generated by system intelligence, or any combination of the two.

In at least one example, system intelligence may include the use of the correlator 130. An exemplary correlator is described in more detail in co-pending U.S. patent application Ser. No. 12/574,069, filed Oct. 6, 2009, and entitled “CORRELATING WEB PAGE VISITS AND CONVERSIONS WITH EXTERNAL REFERENCES,” the disclosure of which is hereby incorporated by reference in its entirety. In at least one implementation, the correlator 130 can determine how visitors are directed to the entity and how those visitors behave once there. For example, the correlator 130 can determine which keywords were associated with directing the visitor to the entity and/or what types of pages the visitor accessed en route to the entity.

In at least one example, the grouping engine 140 may be configured to analyze the keywords returned by the correlator 130. For example, the grouping engine 140 may be configured to analyze the keywords returned by the correlator 130 to determine categories of keywords that appear in proximity with each other. Such an example will be discussed in more detail hereinafter. The grouping engine 140 may also be configured to cooperate with the deep index engine 120 to surface additional keyword variants or page types, which may be included in additional page types and/or included in previously searched page types. Accordingly, the correlator may be configured to surface terms for inclusion in the page types based on the co-occurrence of those terms with the terms of the original page types. Such an example will also be discussed in more detail hereinafter. Presently, a method for optimizing search engine results for a particular page type will be discussed.

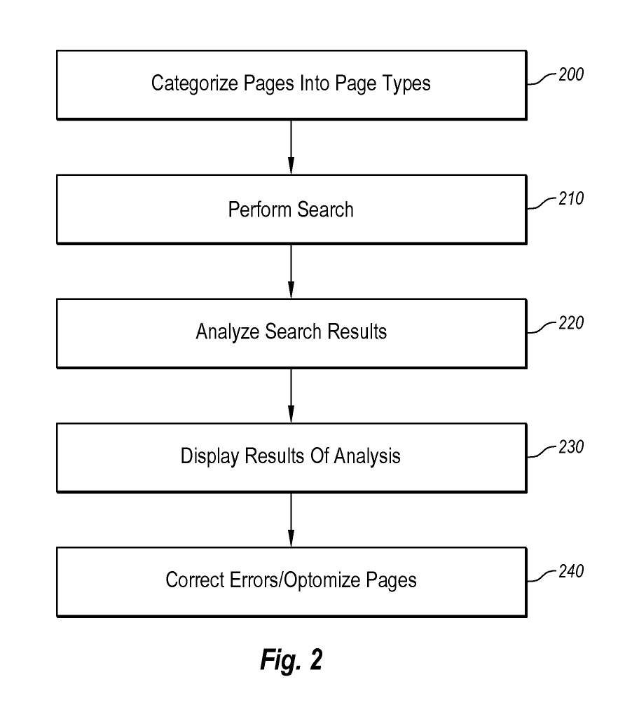

FIG. 2 illustrates a flowchart of an exemplary method of optimizing search engine results for a particular page type of an entity. The method can be implemented using software, hardware or any combination thereof. If the method is implemented using hardware, the acts of the method can be stored in a computer-readable medium, to be accessed as needed to perform their functions. Additionally, if the method is implemented using hardware, the acts can be carried out by a processor, field-programmable gate array (FPGA) or any other logic device capable of carrying out software instructions or other logic functions.

Additionally or alternatively, the method can be implemented using a server or other single computing environment. If a server or other single computing environment is utilized, the conversions need not be divided into groups, since all conversions will be analyzed by the same server or single computing environment. Accordingly, less overall processing can be necessary. However, the server or single computing environment can experience downtime or otherwise delay the results.

As illustrated in FIG. 2, the method begins at act 200 by categorizing a plurality of web pages into page types. These page types may include user-defined page types, automatic system-defined page types or some combination of the two. For example, the page types may be categorized by grouping the web pages into categories, each category including a set of web pages related to one another by keyword, subject, topic, area of interest, or other user-defined parameter. An entity or company that maintains a web site or multiple web sites, each including multiple web pages, may categorize each of the web pages into a page type.

The web pages may be grouped according to an indicator, such as a term in a URL string of the web page, which may be used to group the web pages into one or more page types. The URLs may be in different formats for different devices such as a computer, tablet, mobile kiosk, smartphone (e.g. IPHONE device or ANDROID device), personal digital assistant, etc. As a non-limiting example, the URL string for each of the web pages of a page type for “golf” may include “/golf/” in the URL string. As another non-limiting example, web pages including “/golf/” in the URL string may be included in a page type for “sporting equipment” or “sporting apparel.” The indicator may be used to determine which web pages belong to the page type, thus, enabling categorization of the web pages according to the page type.

With continuing reference to FIG. 2, once the web pages have been categorized into page types, the method continues at act 210 by performing one or more search jobs in which the terms associated with the web pages of the page types determined at step 200 are searched. The terms associated with the web pages may be searched individually and/or in any desired combination.

Once the search jobs have been performed, at act 220, the results of the search jobs are analyzed and the page types are managed. For example, the output of various search engines may be analyzed to determine where an entity is positioned when the terms associated with the page types are searched. Analysis can then be conducted to map out and identify the best performing page types and to determine keyword variants. At act 230, the results of the analysis are displayed to a user. At act 240, a remediation or optimization process may be performed based on the results of the analysis.

Accordingly, categorizing a plurality of web pages by grouping each of the web pages into one or more categories how customers have them arranged, they can better manage the information. The benefit is that customer can easily see how metrics related to a group of pages. For example, if all the web pages of a website that include a common identifier in their URLs are not working properly, a client may be alerted that all of web pages including the identifier in the URL need to be modified or updated. As a non-limiting example, each of the web pages including “/golf/” in the URL string may not have a proper title and the client may be notified that the title should be updated for these web pages.

Additionally or alternatively, the method can be implemented using a server or other single computing environment. If a server or other single computing environment is utilized, the conversions need not be divided into groups, since all conversions will be analyzed by the same server or single computing environment.

The selection as to how the page types are to be determined may be received in any desired manner, such as through the use of input/output devices. This input may be received at an initial setup stage, received before each search is performed, or received at any desired time.

For example, the user may directly define the page types. In particular, with respect to user-defined page types, users may be aware of keywords, keyword variants, or keyword categories for actions that are related to the entity, such as traffic, events/interaction with the website including conversion events, purchase/sale, download, signup, or any other actions. For example, a user may define groups such as keyword page types based on keyword category or keyword variant that combine laudatory words, a category of interest, and a geographical category. One such exemplary grouping could include the phrase “best restaurants” +[city] (e.g., best restaurants in San Francisco, best restaurants in New York, etc.).

Accordingly, the external reference can include a group of external references. For example, a webmaster can be interested in the number of conversions based on a search that includes different city names. For example, if a business is located in numerous cities, the webmaster can be interested in the number of conversions that come from a keyword search that includes any of the city names, regardless of which city is actually searched. Accordingly, the external references can be grouped with one another as a single page type, regardless of which city is actually searched.

In addition to entering keywords directly, users may also be able to group pages into page types by various other methods. For example, a user may be able to group product page types, editorial pages, blog posts, or other categories together. In at least one example, a user may create user-defined templates by grouping page types together as desired. As introduced, the method may also include determining page types automatically.

In at least one implementation, correlating external references to a web page with the number of conversions on the web page can allow the webmaster to determine the number of conversions provided by each external reference. This can, in turn, allow a webmaster to focus on increasing the number or quality of references that will best lead to an increased number of conversions on the web page. For example, correlating keyword searches and the ranking of the web page within the search results, in search engines that include a reference to the web page, can allow a webmaster to focus on improving the ranking of the web page in searches for identified keywords that are more likely to lead to a greater number of conversions. Correlating conversions by a visitor on a web page with an external reference can allow a webmaster to determine which external references are best at producing conversions.

Additionally or alternatively, the value of each of the terms may be assigned by determining the estimated search frequency of the terms associated with each page type. The system may estimate the search frequency of the terms associated with each by determining which external references linked to a web page of the page type and performing analytics on the external reference. These analytics may include crawling the references and determining the keyword frequency on each of the pages. In at least one implementation, the analytics of the external reference can include one or more channels. In particular, channels can include organic searches, organic links, paid links, page searches, linked advertisement networks, banner advertisements, contextual advertisements, e-mail, blogs, social networks, social news, affiliate marketing, mobile advertisements, media advertisements, video advertisements, videos, images, discussion forums, paid advertisements, display advertisements, news sites, rich media, social bookmarks, paid searches, wiki, mobile content, and in-game advertisements. Nevertheless, the channels are not limited to those mentioned, but can include any relevant areas of the network, whether now existing or created in the future.

Additionally or alternatively, the analytics of the external reference can include one or more signals. In at least one implementation, the one or more signals include information about the external references to the web page. For example, advertisements placed at the top of a web page are much more visible, and therefore, are generally more expensive and are considered more effective than advertisements placed at the bottom of a web page. Therefore, if the external reference includes online advertisements, advertisement placement is an analytic of the web page that can be evaluated.

Alternately or additionally, the one or more signals can include a keyword used in a search which identified the web page and the ranking of the web page within the search, and the competitive listings (other pages that rank within the search). Additionally or alternatively, the one or more signals can include one or more of: calendar date of the external reference, time of day the external reference was accessed or the like.

As previously introduced, automatically determining page types may include conducting a word frequency analysis search for each of the terms with respect to competitive listings.

Additionally of alternatively, incoming links from third party websites may be grouped into meaningful page types (based on the content of the page) for the purpose of conducting analysis to understand the value of a link from a given page type or the value to the business of actions related to the entity that are driven from a given page type. These results may provide meaningful insight and actionable opportunities based on aggregated data analysis applied to individual page types, combinations of page types, or by comparing page types.

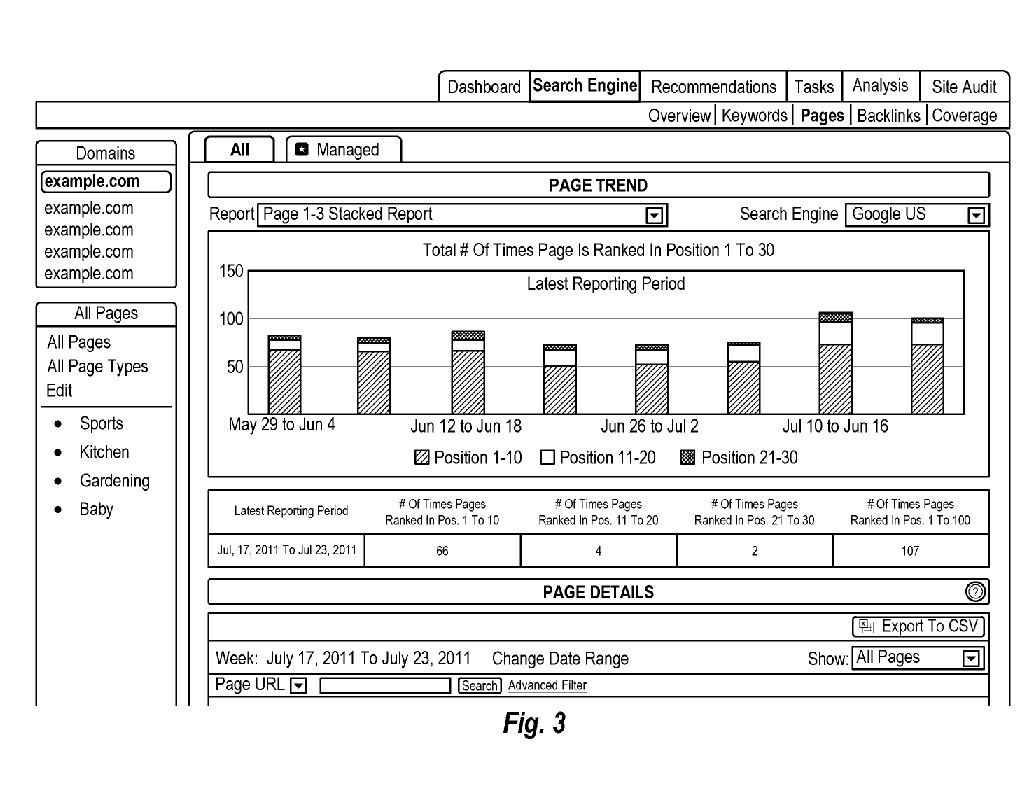

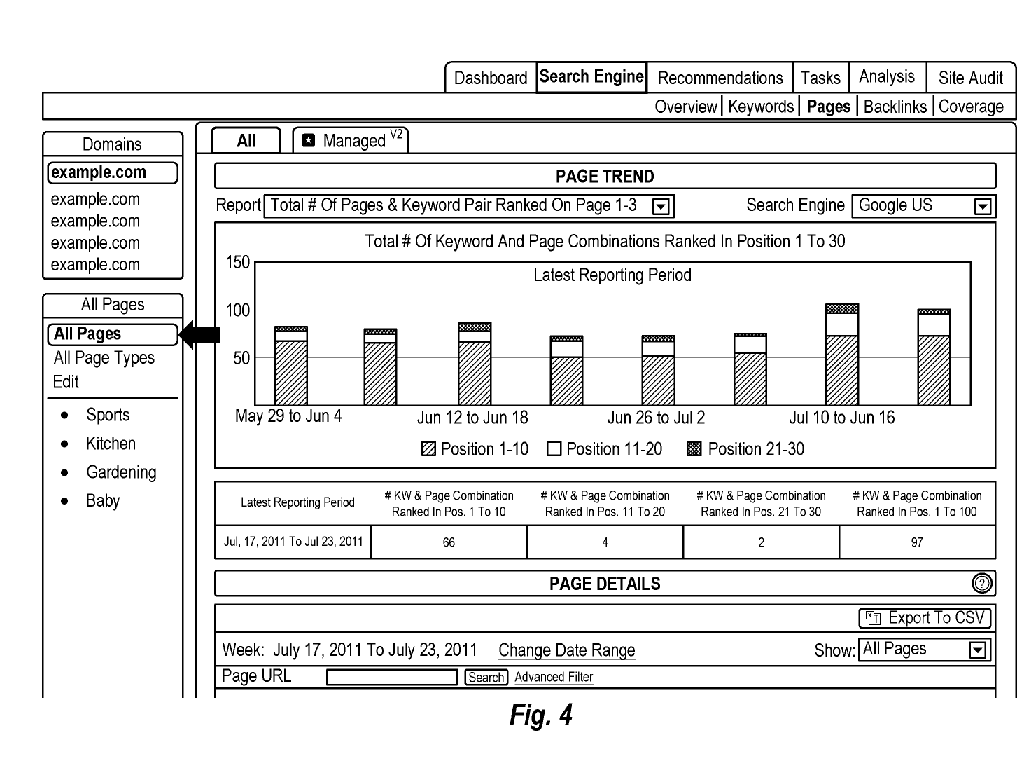

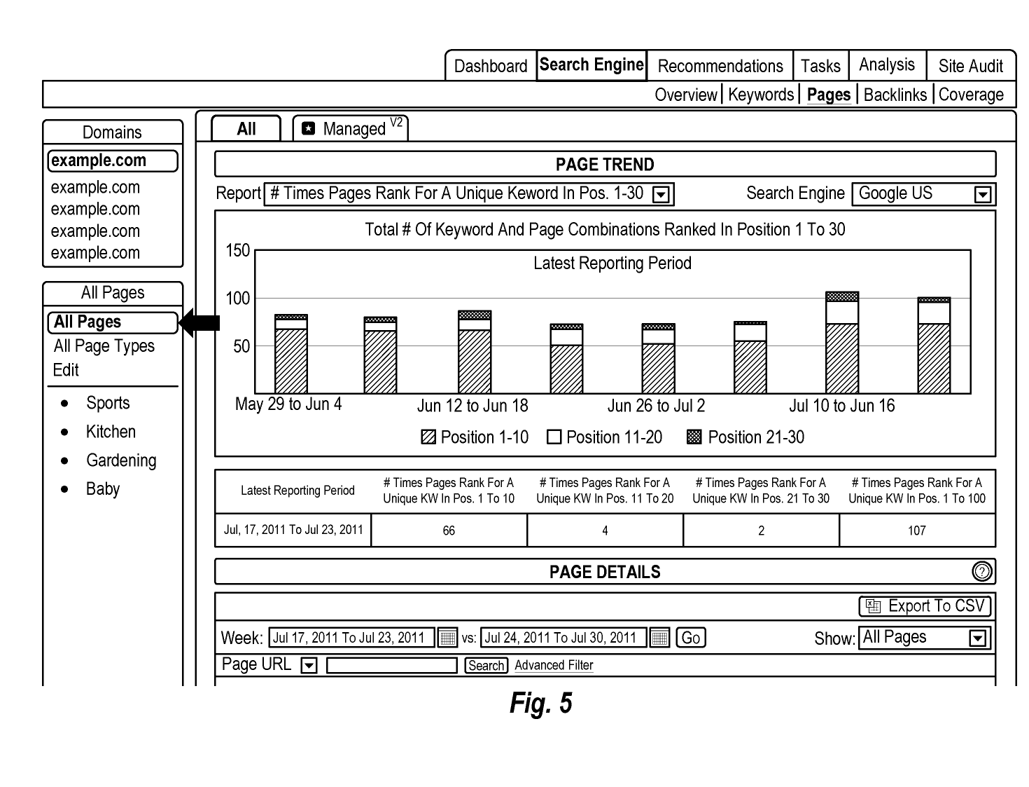

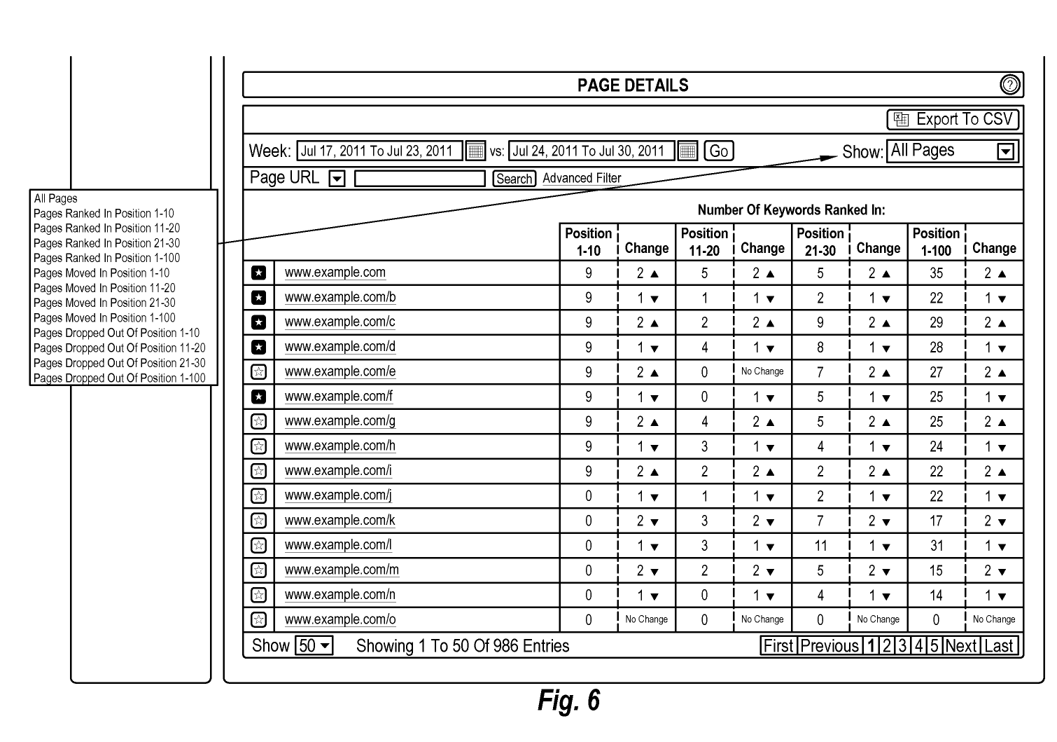

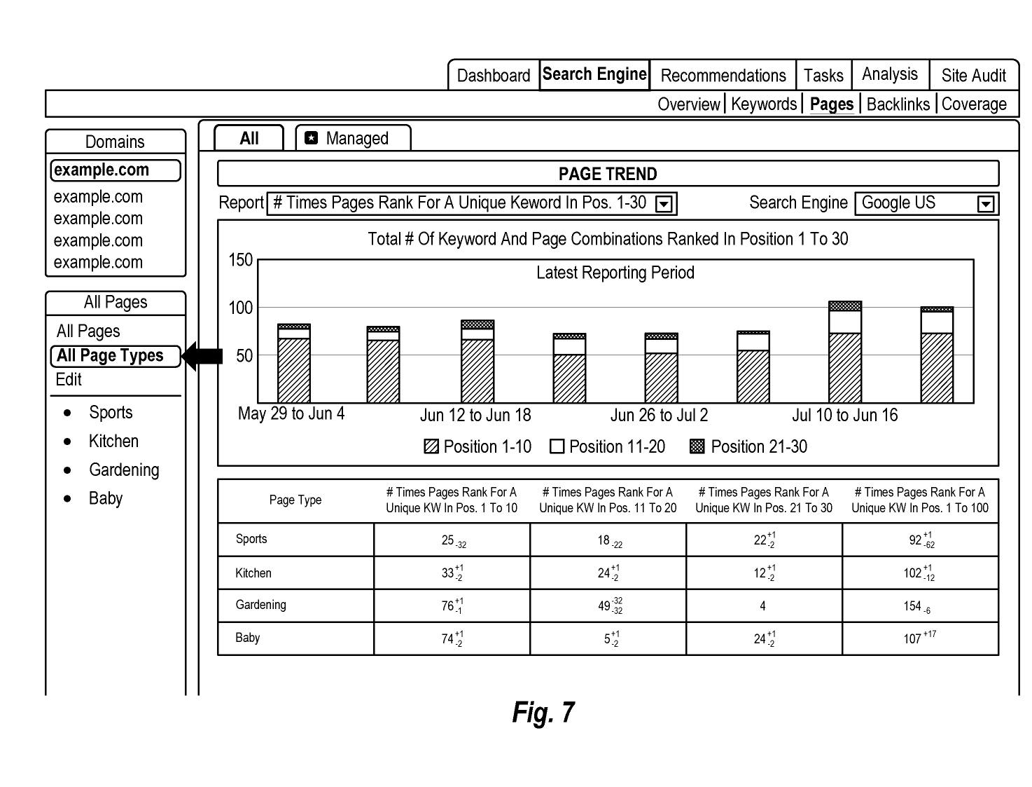

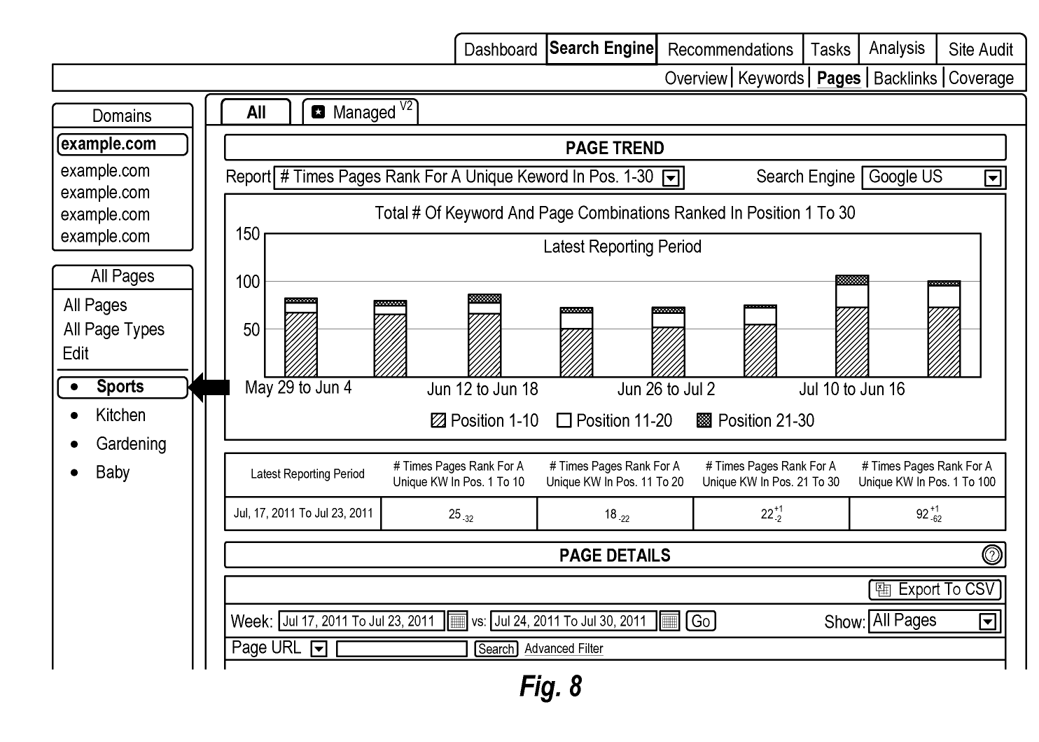

Accordingly, the method may include performance reporting of the page types. For example, FIGS. 3-6 illustrate performance reporting for all of the pages of an entity. FIGS. 7-8 illustrate performance reporting which may result for a particular page type. Reporting performance by grouping may include simultaneous displaying each of the results described above or comparisons to other page types. These results may allow the entity to diagnose business performance. In particular, if overall actions related to the entity or conversions have dropped, the display may allow the entity to identify what page types are dropping. Further, based on the results above, these results can be selected as desired to focus on areas of concern or to identify opportunities as desired.

Performance reporting by page type can also include displaying cost parameters, such as project costs, lead times, or other investment parameters along with the results previously described. Displaying the cost parameters can allow marketers to understand and test a segment before scaling content for the segment. Further, such a display can allow for effective project and campaign management.

In particular, before embarking on a new content campaign, a forecaster may be able to use the parameters shown on the report to forecast the return on investment of the potential campaign based on the targeted value of the page type. Once the campaign has been initiated, the display may allow the marketer to readily measure the return on investment of the campaign against effort, including costs and time.

Performance reporting for a page may also include an indication of the average amount of time a user spends on a particular page or group of pages, a number of page views for a given page or set of pages, or conversion goals indicating the number of purchases or sales that result from visits to a particular site or group of sites. Other performance data may include a number of backlinks a page URL has, the number of media objects such as “likes,” “shares,” “posts,” or the like that a particular URL has. For example, performance data may indicate the number of times a particular page has been “liked” or “shared” on Facebook or the number of times a particular page has been mentioned in a Twitter tweet.

Performance reporting may also include calculating and displaying aggregated statistics for the above mentioned data and both the individual page level and the page type level.

Performance reporting may also generate a score which is based on a series of metrics, such as estimated traffic to the site, the number of errors on the page, the number of backlinks to the page, and the like or some combination thereof.

Performance reporting may also include generating recommendations by page type. For example, performance reporting may recommend reformatting the template of a particular page type if the pages of that particular page type contain a large number of errors.

Other aspects of performance reporting may include the ability to quantify the value of particular page templates and to track that value over time. Performance rating may also include the ability to identify content management system errors for each page template based on the calculated page performance data. Integration with the content management system may be provided to enable web page content and web page templates to be modified or edited directly through the same interface used to provide the performance reporting.

In some embodiments, performance reporting may also include the ability to identify and correct page template issues for all the pages which are based on a particular template. As such, performance reporting may also provide the ability to perform remediation on issues which exist across an entire page type without requiring that the errors be corrected manually within each page of the page type.

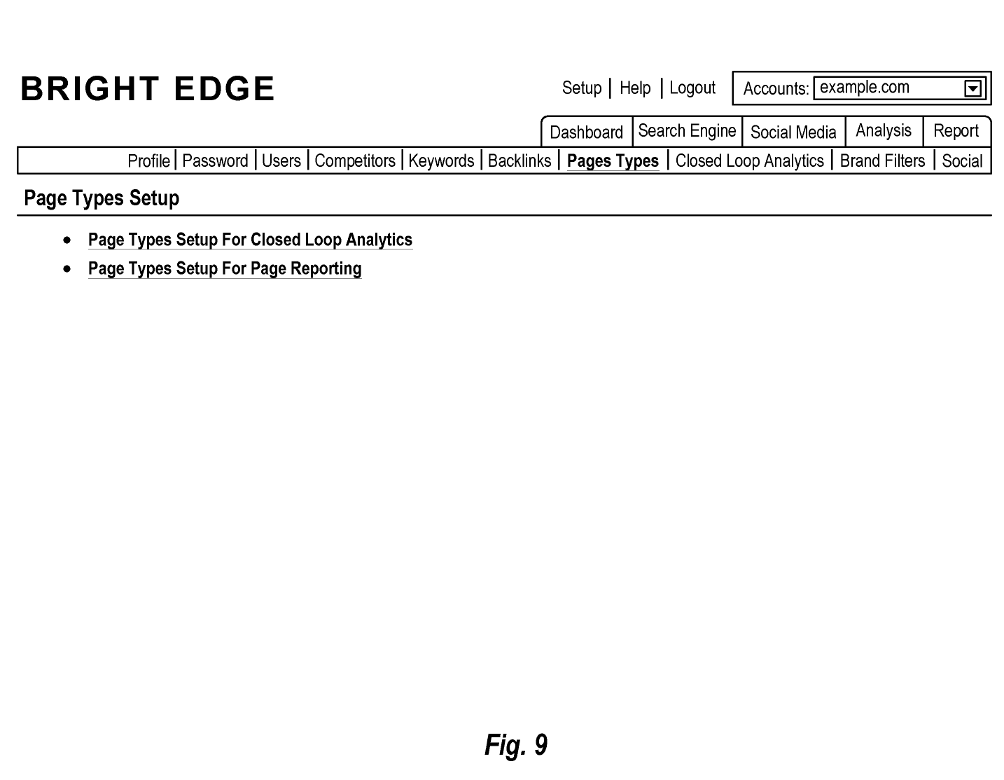

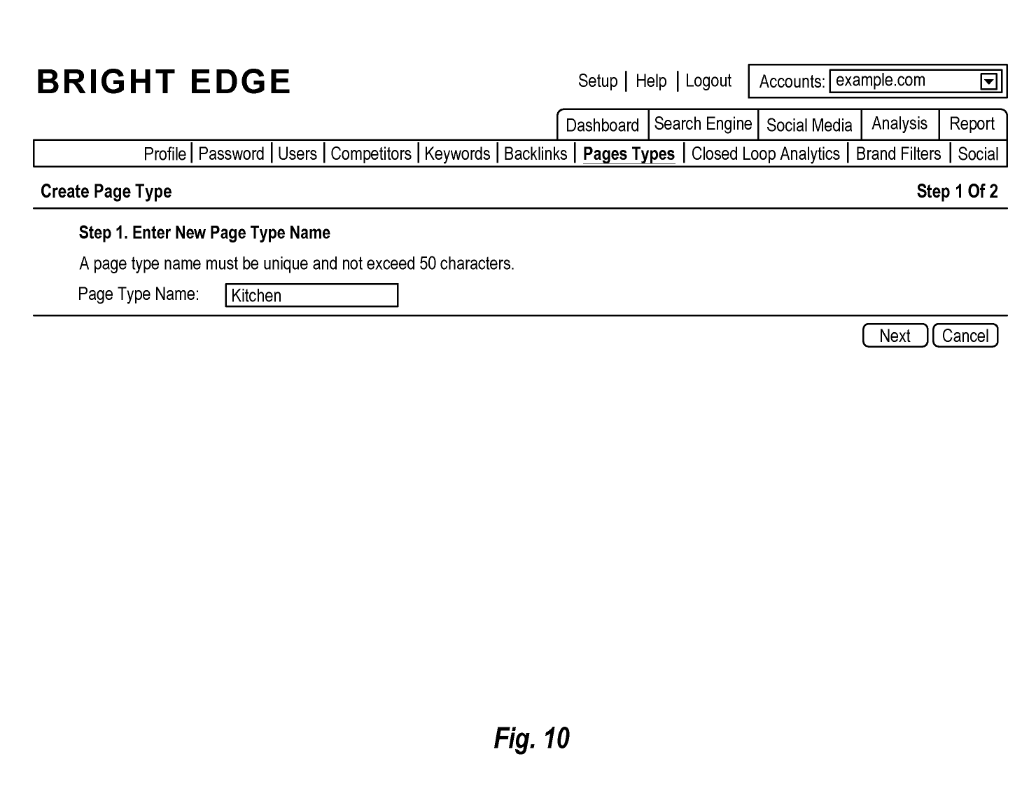

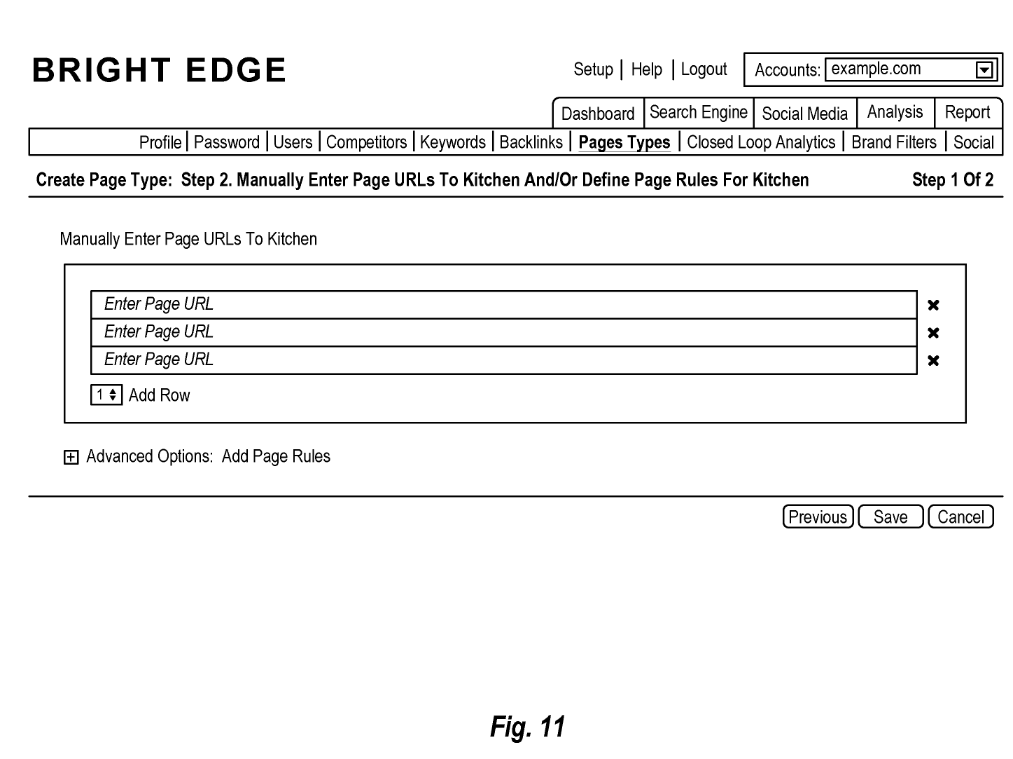

FIGS. 9-14 illustrate various user interfaces which may be used to enable an entity to manually create a page type. FIG. 9 illustrates an initial set up screen which a user initiate the page type. FIG. 10 illustrates a user interface wherein a user can create a name of a particular page type. Using the interface provided in FIG. 11, a user may manually enter a listing a URLs or Web Sites which will be assigned to the selected page type.

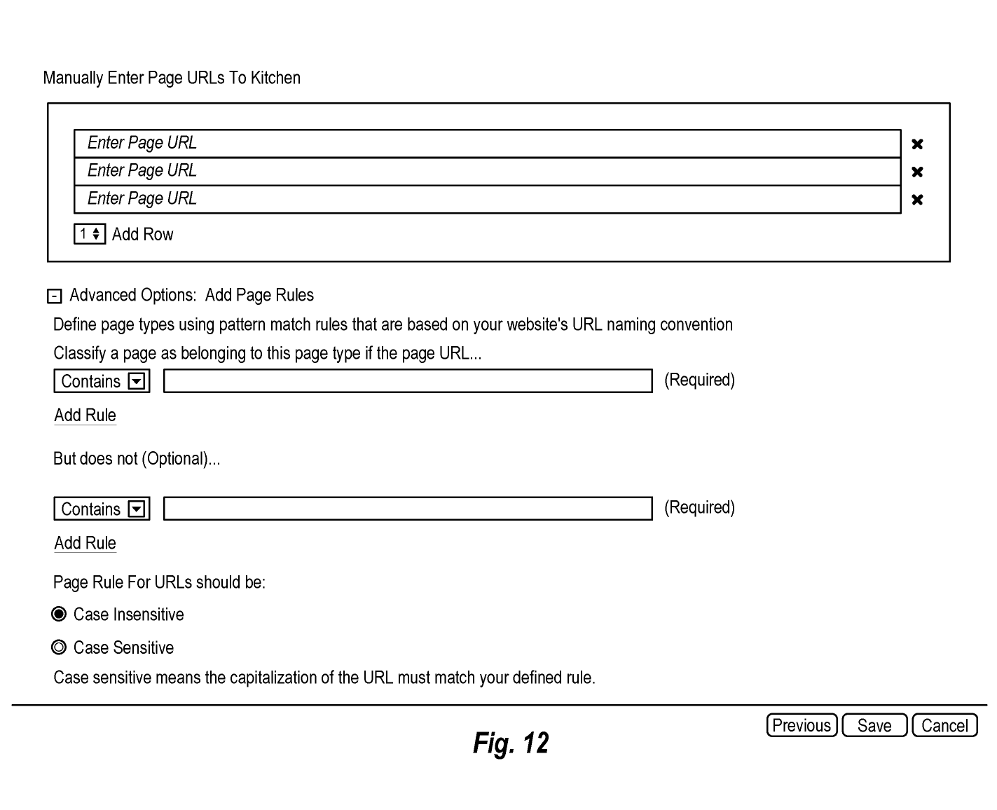

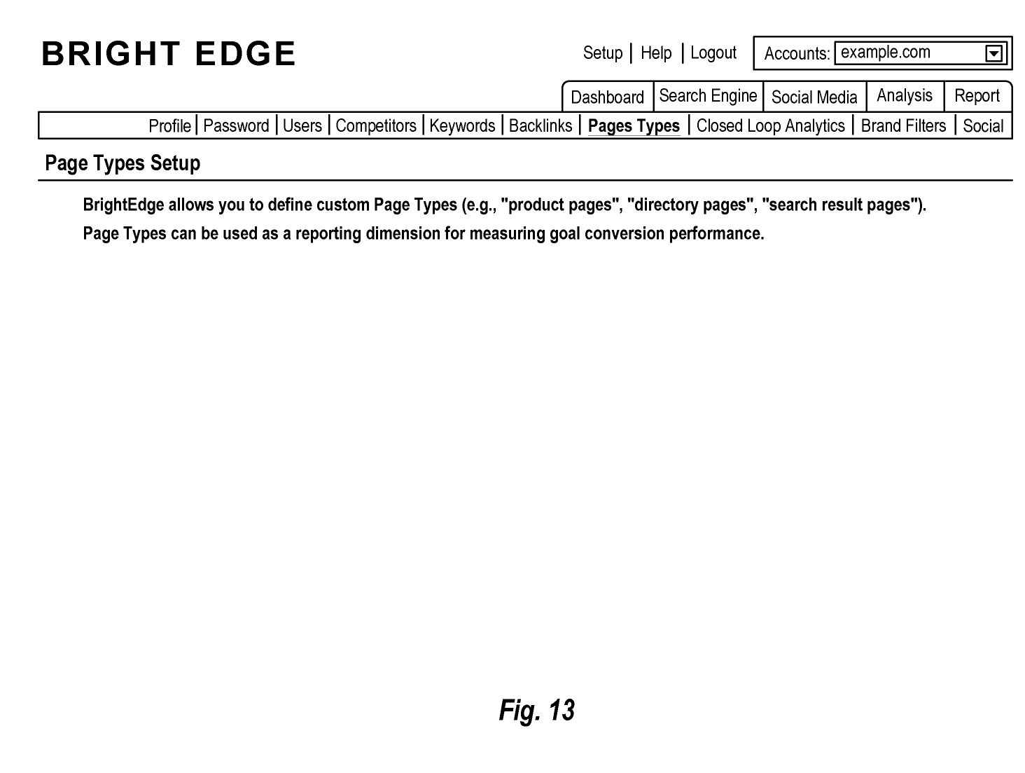

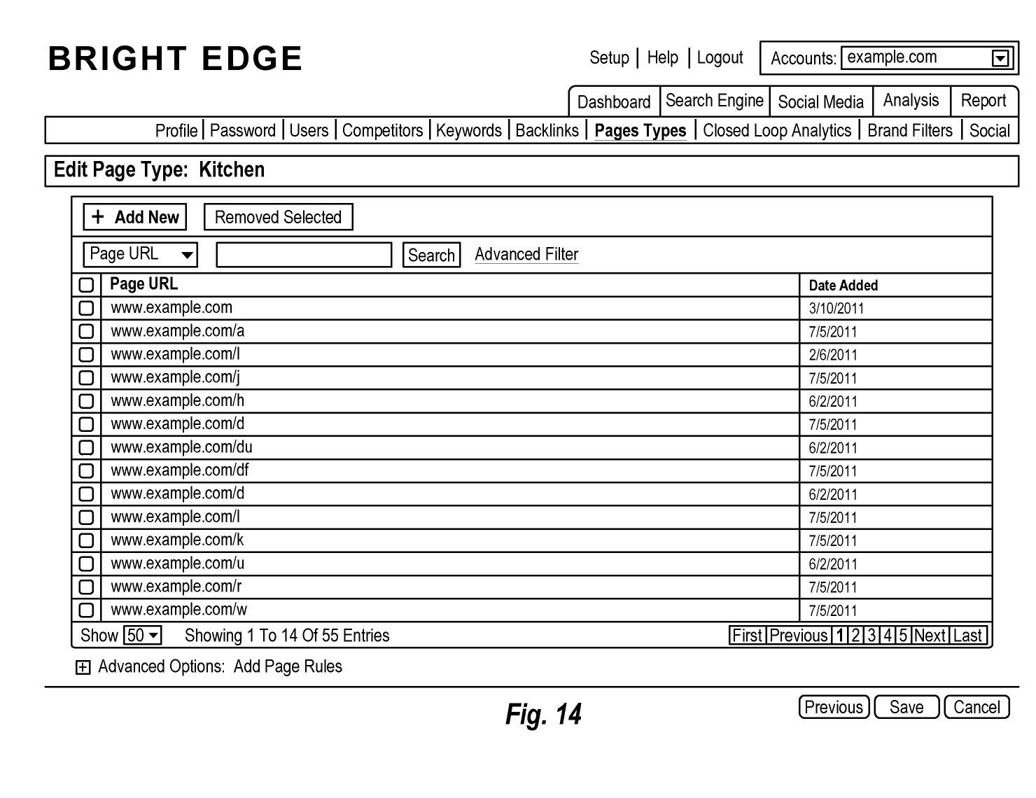

FIG. 12 illustrates the ability to create a set of criteria which the system will use to automatically identify a page as belonging to the page type. FIG. 13 illustrates a page type setup screen wherein a user can see a brief overview of all the different page types that he or she has created. FIG. 14 illustrates a user interface wherein a user may manually add or remove a particular URL from a particular page type.

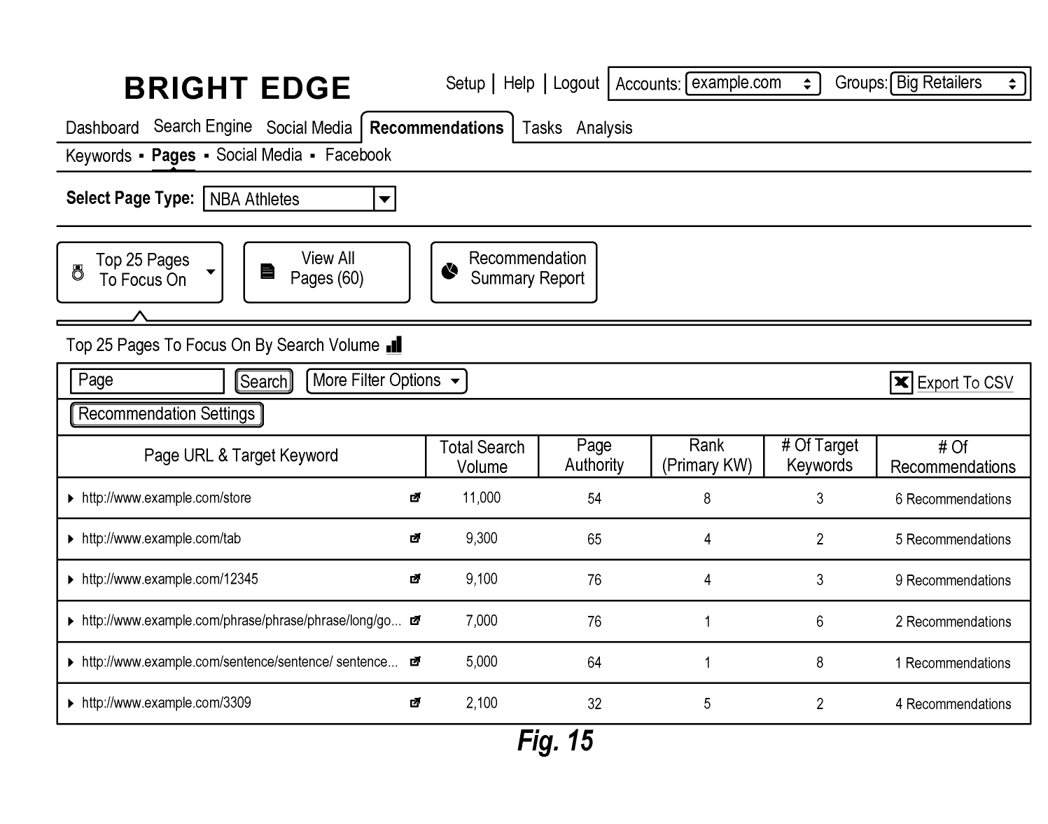

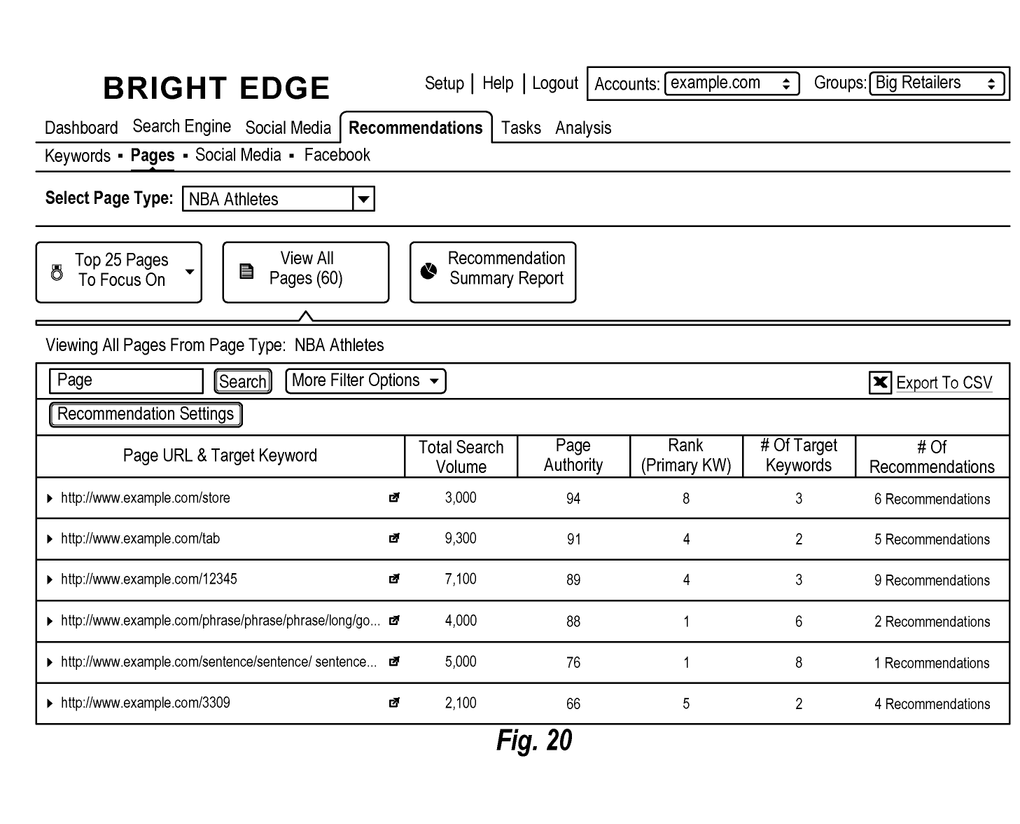

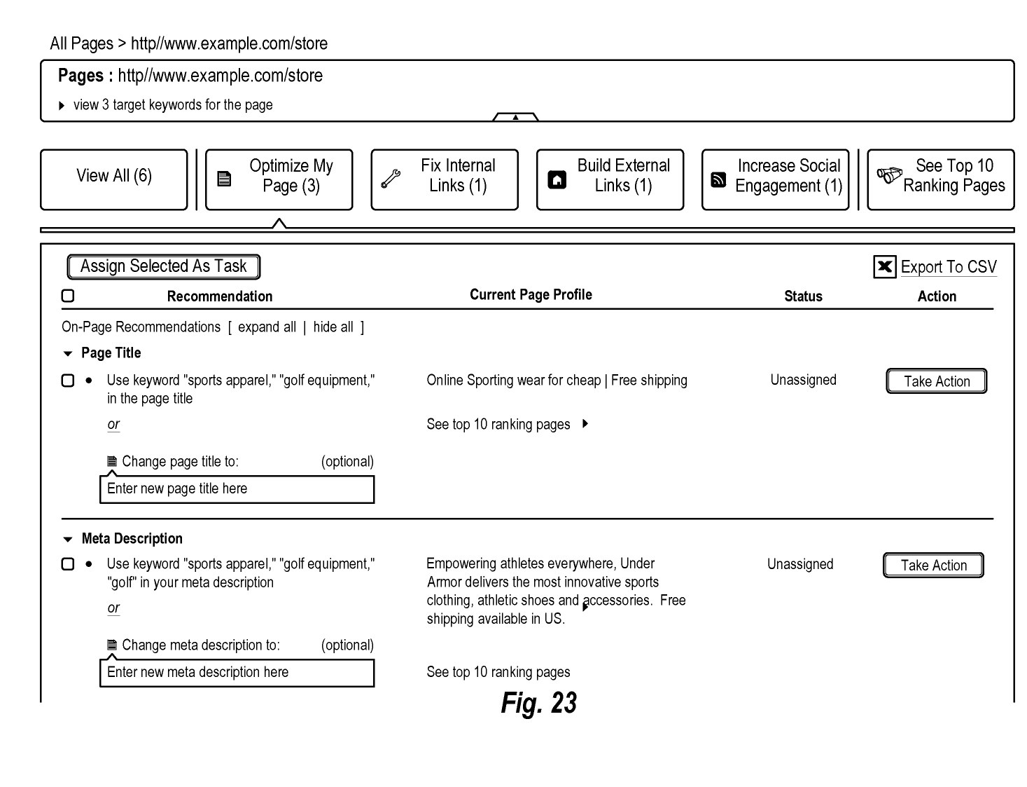

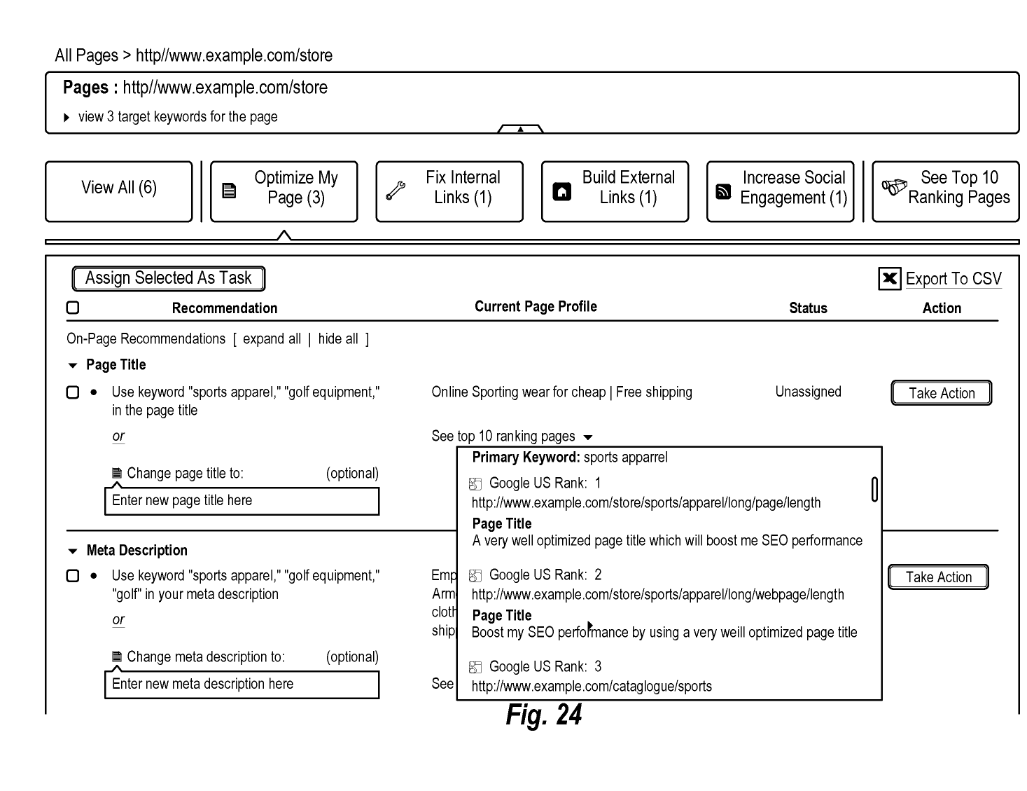

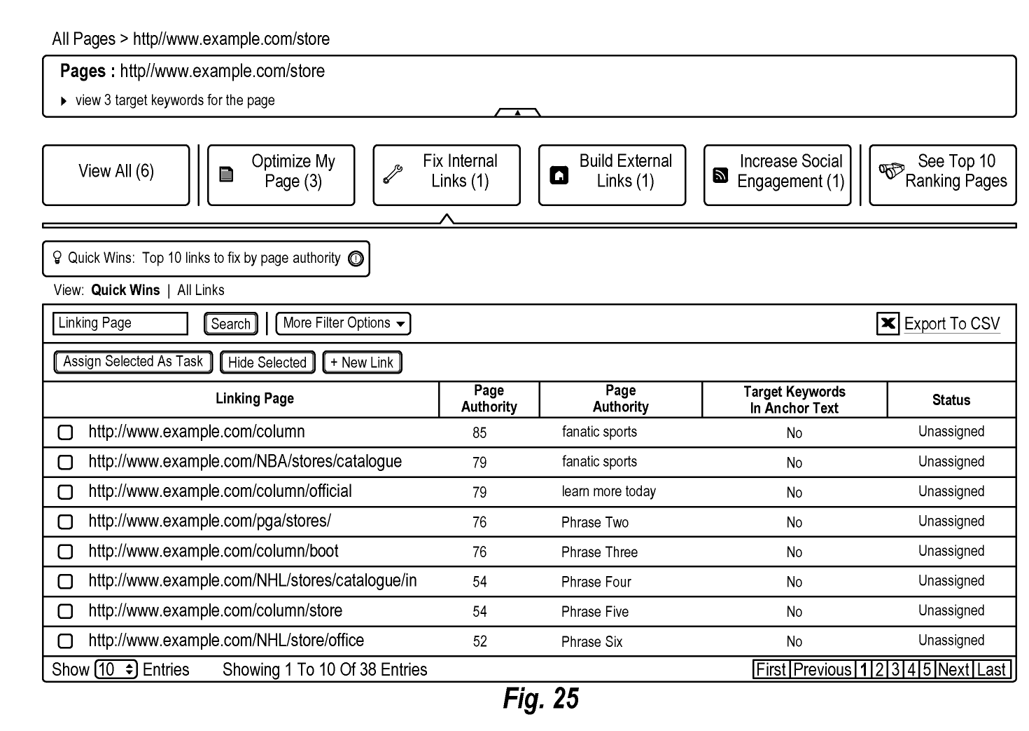

FIGS. 15 through 28 illustrate examples of user interfaces which may be used to enable an entity to access various page reporting tools. As shown in FIG. 15, the user interface may provide recommendations for a set of web pages defined by URLs. The recommendations may be determined by collecting (web crawling) and analyzing information from a network as described with respect to FIGS. 1 and 2. As a non-limiting example, each of the recommendations may be designed to improve the ranking of each of the web pages based on keywords.

The keywords may be selected by the user and the user can indicate any number of keywords. For example, the user interface may include a a text box that enables the user to specify the keywords and the number of keywords. If there are multiple keywords targeted for a web page, the keyword with the highest search volume may be prioritized and treated as the keyword in generating the recommendations. The keywords may be prioritized by search volume, if available. Additionally, the keyword may be prioritized by rank or by alphabetical order. The user may change the priority of the keywords. In embodiments in which a preferred landing page has been assigned, the keywords for a web page will include the keywords such that the web page is the preferred landing page for those keywords.

The recommendations may be provided based on the keywords or based on the web pages. As shown in FIGS. 15-17a, 20, 25 and 26, to provide recommendations based on the web page, a column may be provided to display the URL for the web page and will be paired by the list of keywords that rank on that URL.

Examples of information provided by the user interface for each of the web pages includes, for example, a list of URLs for the web page, tracked keywords that the web page ranks for, average cost-per-click (CPC) value for each tracked keyword; total search volume for the web page (based on the sum of the volume of the individual keywords targeted for the web page); visits to the web page (need integration with analytics); goal conversions for the web page (need integration with analytics); revenue for the web page (need integration with analytics); and total number of recommendations for the web page (including pages with no recommendations). The web pages may be prioritized by total search volume by default, or the user may prioritize the web pages by authority score. As will be described, the user interface may provide buttons or links that enable the user to click on each URL link or number of recommendations to view details.

The recommendations may, thus, be implemented to improve keyword ranking for individual pages that fall within a specified page type. The interface may provide a function that enables the user to select the page type, such as a drop down menu displayed as “Select Page Type.” Any number of page types may be provided, as well as an option to display all pages. In the example illustrated in FIG. 15, the page type “NBA Athletes” has been selected. Thus, recommendations may be provided for web pages categorized within the “NBA Athletes” page type.

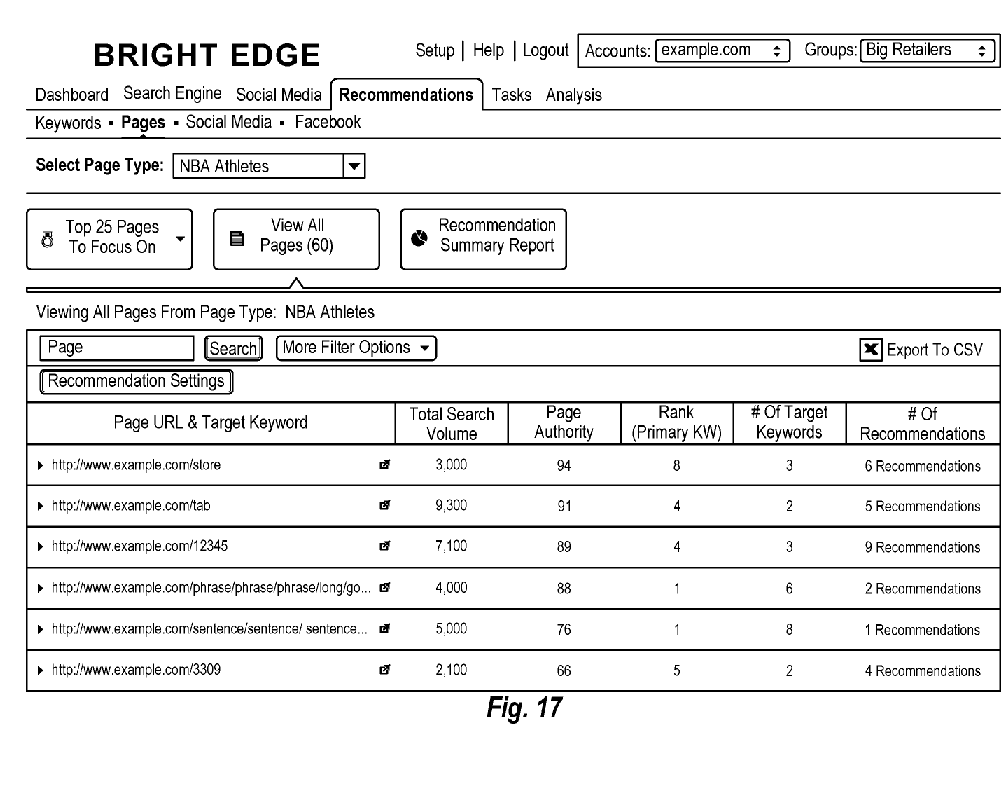

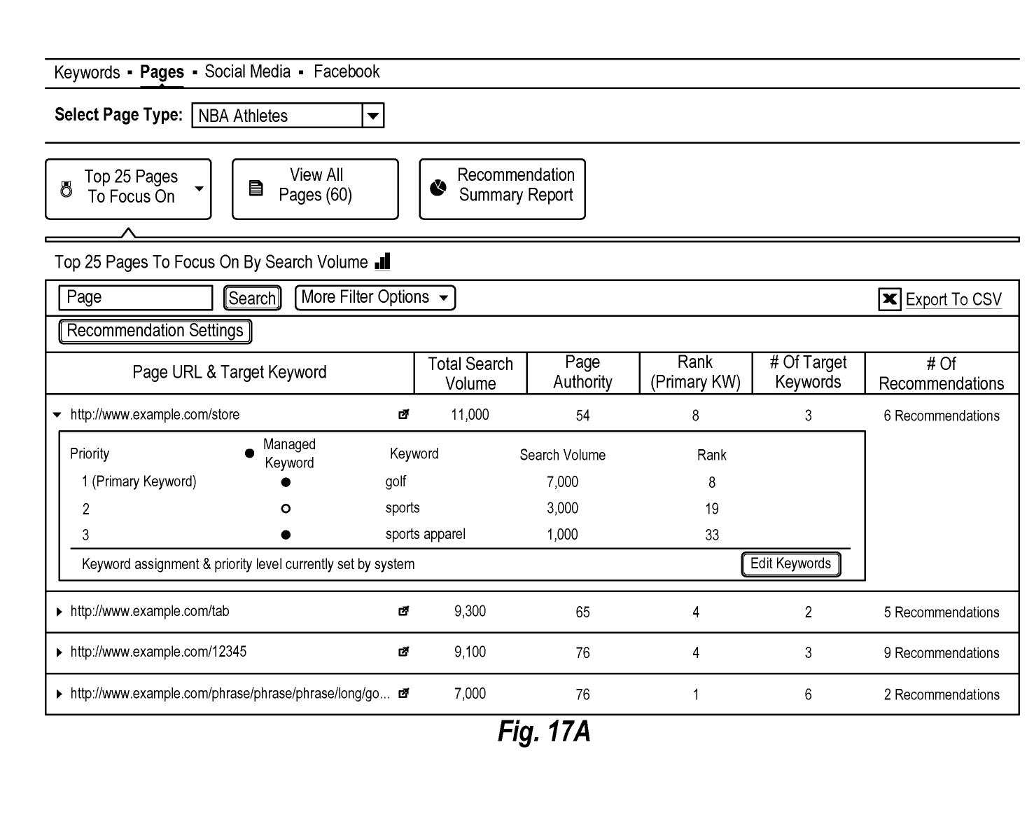

The recommendations user interface may provide options for viewing recommendations, such as, all web pages, top web pages by ranking or number, or a summary report. As shown in FIG. 17, the user interface may enable all web pages for the entity, which are displayed according to the page type or category, if selected. The top ranking web pages may be determined by relevance of the web page, by page rank, by page score or by highest number of recommendations. For example, the user interface may provide an option to view the “Top 25 Pages to Focus On,” which has been selected in the example illustrated in FIG. 15. The top 25 web pages may be displayed by URL and target keyword, for example. For each of the top 25 web pages, the interface may provide any number of recommendations, such as, total search volume, page authority, rank, number (#) of target keywords and number (#) of recommendations. The page authority may be determined using a numeric representation of the web page's global link authority which may be based on a 100-point, logarithmic scale. For example, the page authority score may be a PAGE AUTHORITY score available from SEOMoz or a CITATION FLOW score available from MajesticSEO.

As shown in FIG. 17a, each of the page URLs may be include a button to show information related to the page URL. For example, when the page URL button selected, an URL information panel for the page URL may expand to display the target keywords, which may be defined by the user, and information related to the target keywords, such as, search volume and rank. The URL information panel may enable the user to change the target keywords or to tailor the keyword assignment and/or priority level. A keyword may be added to the priority list by clicking on the target button for a keyword which is currently ranked, but designated as inactive state. A pop-up window or other display may be provided to warn the user that the selected keyword will now be targeted for the selected web page and the previously selected keyword will be designated as inactive. A keyword may be added by clicking the “Add Keywords” or “Edit Keywords” button to add keywords from their tracked list via the add keywords. If the selected keyword is currently targeted for another web page, a warning message will be provided to indicate that the keyword being selected is already targeted for the other web page and this keyword will be targeted for this new web page instead. The keywords may also be removed and will then be placed on an inactive list.

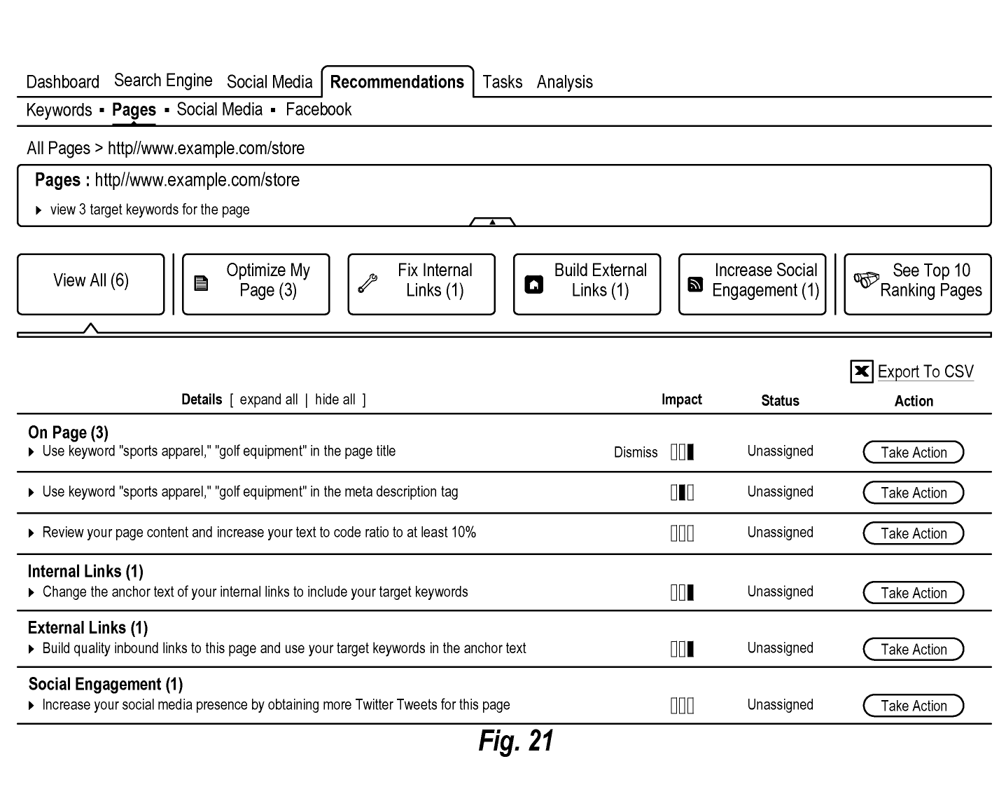

The user interface may provide a button or link providing the user with to access to the recommendations for each of the web pages listed. For example, a number of recommendations provided under the “# of Recommendations” heading may include a link to another display within the user interface, as shown in FIG. 21.

The user interface may display recommendations for the web pages crawled using the system 100 described with respect to FIG. 1, for example. The web pages may include top ranked pages for the tracked keywords as well as preferred landing pages. As a non-limiting example, tens of thousands of web pages may be crawled in addition to top page and preferred landing page. The recommendations may be provided for the web pages where there is no keyword targeted for that web page.

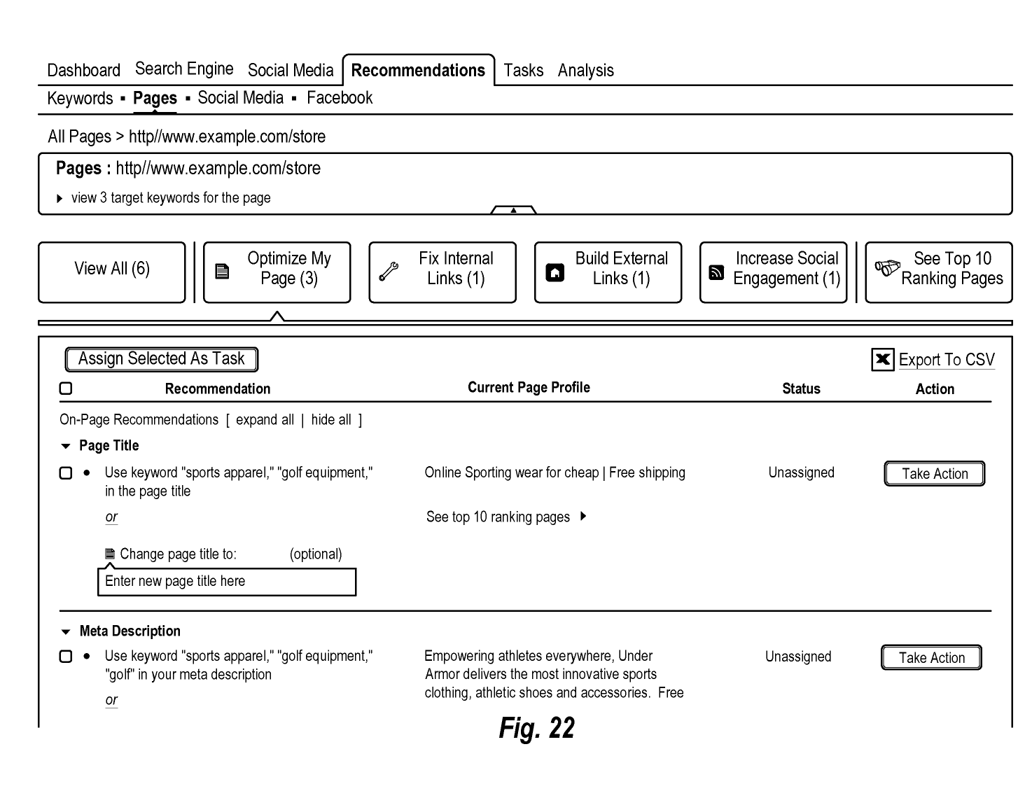

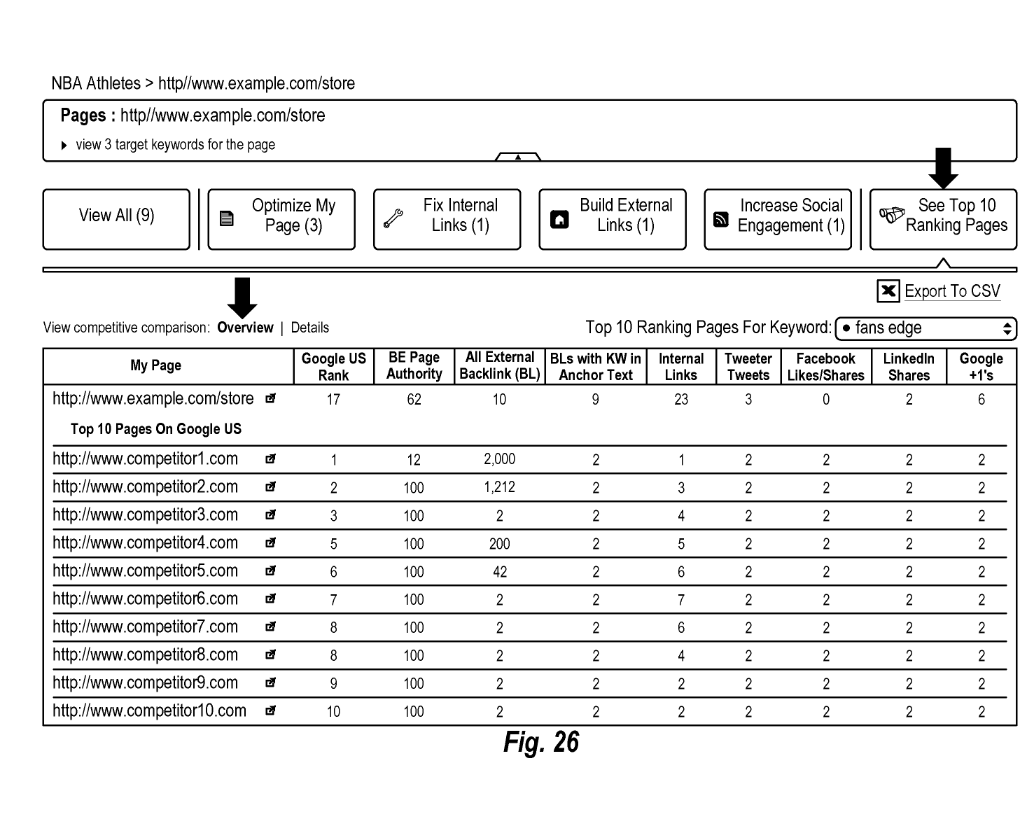

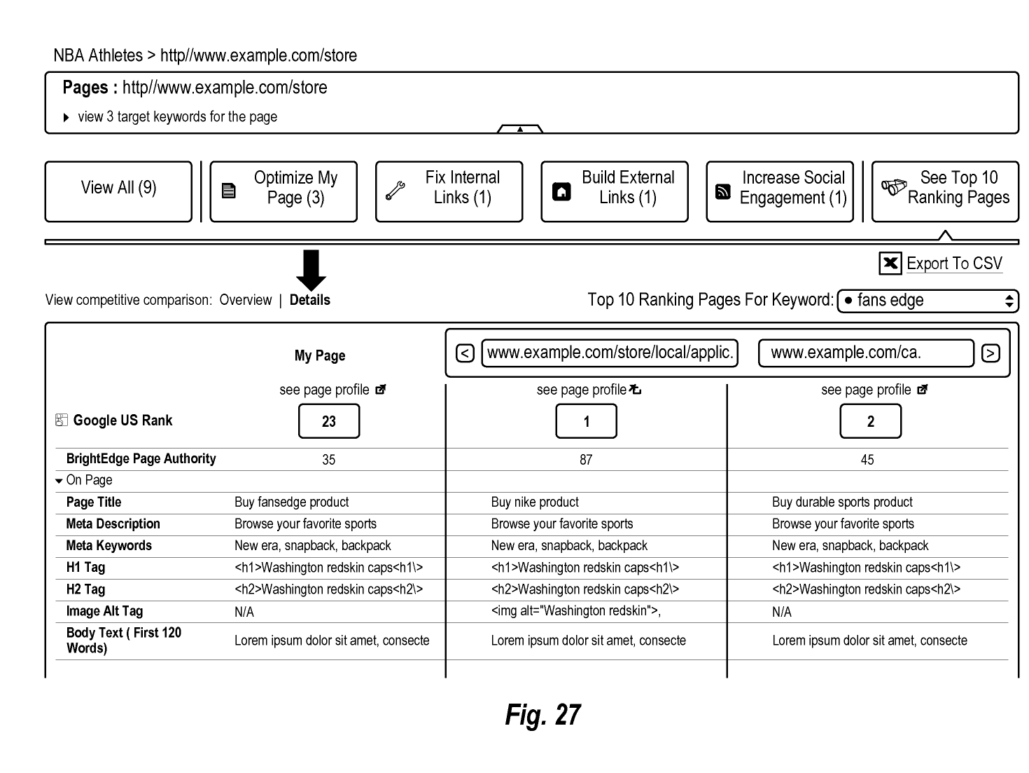

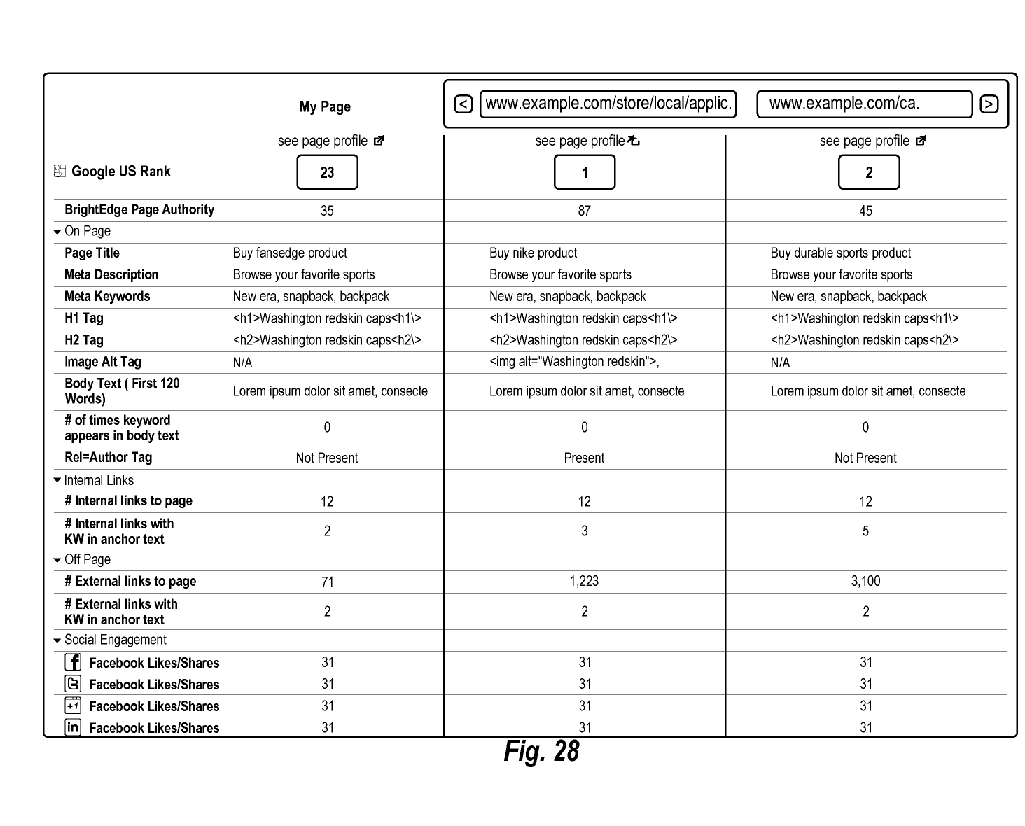

As shown in FIG. 21, the recommendations provided for each page may be provided by category, such as, recommendations for updating information on the web page (“On Page”), in internal links (“Internal Links”), in external links (“External Links”) and in social engagement (“Social Engagement”). For example, the on page recommendations may include recommendations for changing elements within the web page, such as, the page URL, the page meta description, the page title, etc. The user interface may provide any number of options for viewing the recommendations, such as by the category of recommendation. As non-limiting examples, the options for viewing the recommendations for the web page may include “View All,” “Optimize My Page,” “Fix Internal Links,” “Build External Links,” “Increase Social Engagement,” and “See Top 10 Ranking Pages.” A button or link to another subset of web pages may also be provided. FIGS. 22-25 illustrate examples of the user interface that provides recommendations for the web page based on selections of “View All,” “Optimize My Page” and “Fix Internal Links,” respectively. FIGS. 26-28 illustrate examples of the user interface that provides data for a set of top ranking pages showing a comparison of details of selected competitors (“See Top 10 Ranking Pages”). As shown in FIG. 26, the user may select to view the data as an “overview” which provides a summary of the data for each competitor and, as shown in FIGS. 27 and 28, the user may select to view the data by “details” which provides the details of competitors' web pages by element. Thus, the method enables the user visualize side-by-side specific elements of on-page factors next to the web pages of their top 10 competitors.

The “Fix Internal Links” selection may provide recommendations for optimizing internal links. As used herein, the term “internal link” may refer to other web pages from the same domain as the web pages that are analyzed to generate the recommendations. The internal links pointing to a given page URL for one of the web pages is analyzed and improvement opportunities, such as changing the anchor text used in those internal links, is provided as the recommendation.

As shown in FIGS. 22-24, the “Optimize My Page” selection may include on-page recommendations generated for the web pages. The information may be displayed by current page profile (e.g., current page title), recommendations, assign task and top 10 competitive details for that on web page. One or more of the elements of the web page may be displayed even if no recommendation is provided for those elements so that the user may optimize these additional elements. The recommendations may be displayed at the top while the other elements may be displayed at the bottom. If no on-page recommendations are generated, the elements which the user can optimize (e.g., page title, meta description tag, H1 tag, H2 tag and image alt text) may still be displayed. For each of the recommendations, a current profile for the top 10 ranking pages based on one or more of the keywords (e.g., the target or primary keyword) for that page for every line item may be provided.

The page URL may also be optimized for different content types such as videos, images, audio, etc. Accordingly, the recommendation enables the user to create content for different channels (e.g., videos, audio, images, etc.) that may improve the ranking of the web pages.

Each of the recommendations may be assigned to a task. For example, the task may be assigned to the individual elements of the web page, such as H1 tag or page title tag, or to all changes for the web page.

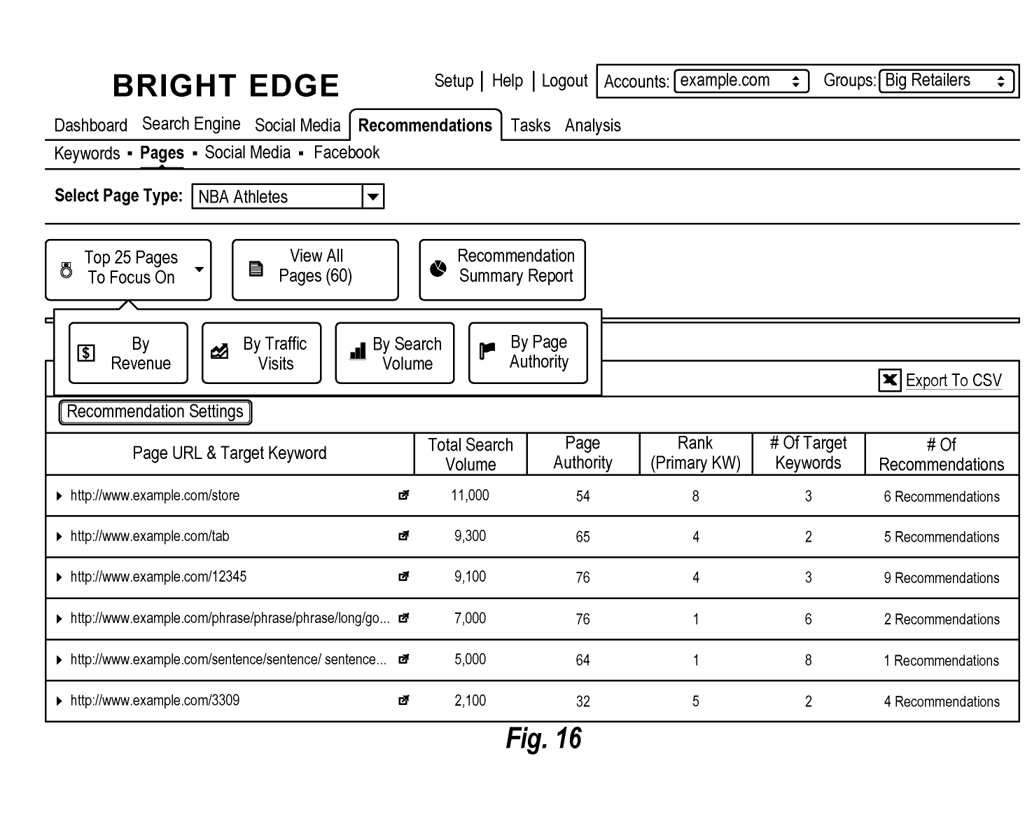

As shown in FIG. 16, the user interface may provide multiple tools for analyzing the top pages to focus on. For example, the user interface may enable analysis of the top pages by revenue, traffic visits, search volume and page authority.

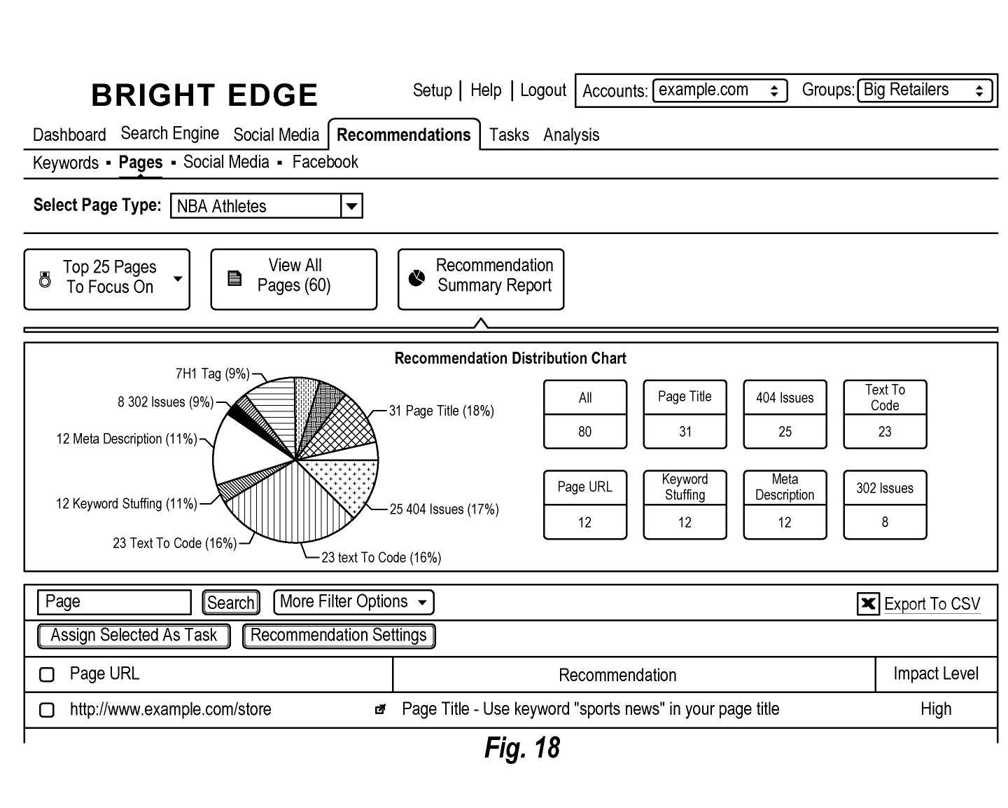

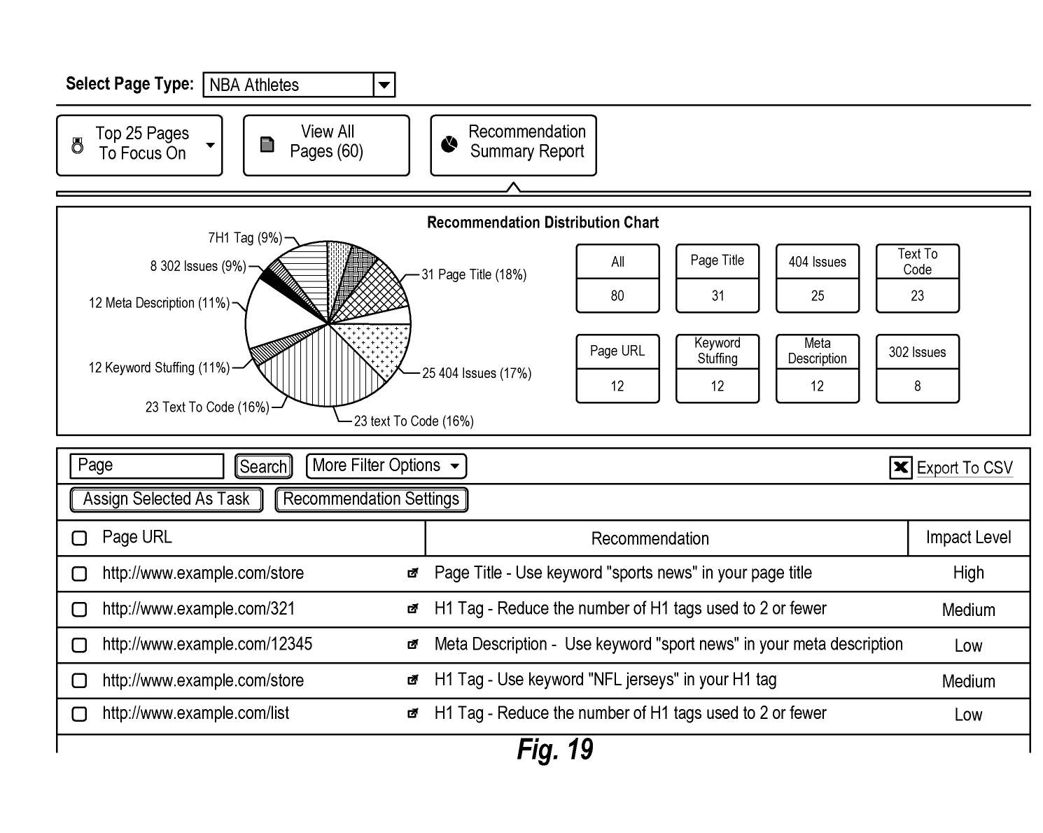

Referring to FIGS. 18 and 19, the recommendation summary report provided via the user interface may include a breakdown of the types of recommendation, which may displayed in the form of a chart showing a distribution of the recommendations by classification.

In some embodiments, the user may implement the recommendations, for example, by accessing a content management system and making one or more changes to the web page and then reporting the changes using the user interface. The web pages may then be crawled to determine if the recommendations should be updated based on the changes. In other embodiments, the user interface may be integrated with a content management system to enable the user to directly make changes to the web pages in accordance with the recommendations.

Referring to FIG. 22-24, the user interface providing the web analytics may be configured to enable the user to implement changes to one or more of the webpages based on the recommendations. For example, the user interface may be integrated with a content management system (CMS). As shown in FIG. 22-24, the user interface may provide a field tied to one or more of the recommendations and the user may provide within the field instructions for changing elements within the web page, such as, the page URL, the page meta description, the page title, etc. The user interface, which is linked with the content management system, may then directly implement the change to the web page or to modify a template for the web page using the provided instructions. As a non-limiting example, an error in the template for a specified page type may be identified and the user interface may be linked to the content management system such that a modification or correction to the template input into the user interface may be directly implemented within the content management system. As another non-limiting example, the

For example, the user may log into the user interface and may view the following recommendation: “www.url.com/abc—‘Use keyword “Sports Apparel” in your page title.’” The user may have the option to overwrite the recommendation by specifying a desired page title. For example, the user may enter the following in response to the recommendation: “Change page title to: Sports Apparel for Cheap|Free Shipping All Day.” Once the user specifies the modification, such as a new page title, meta descriptions, tags, etc., using the user interface, the modification may be automatically made to the web pages by the user's content management system. For example, the user's content management system automatically detects that a new page title has been defined for www.url.com/abc and makes that change automatically. Thus, content management system automation is provided that enables automatic updates to the web pages based on the recommendations.

The recommendation may also include information about high authority sites that may be used to obtained backlinks directed to the web pages. The high authority sites may be web sites determined to contain more valuable content in comparison to other web sites, the determination being made by one or more search engines, for example. Such high authority sites (e.g., cnn.com, espn.com, foxnews.com, etc.) may be identified and may be provided to the user as a recommendation that enables the user to contact the high authority site to obtain backlinks to one or more of the web pages. Providing the backlinks obtained from the high authority site on the web pages may improve the ranking of the web pages.

The recommendation may also include information enabling the user to drive customer engagement based on trending topics. For example, trends for a specific web page may be identified by analyzing the data obtained from the web page. The recommendation may be generated to drive engagement for that page based on the trend identified for the web page. For example, a particular URL may be ranking highly for a specific keyword during a period of time and recommendations may be provided on how to drive more engagement, such as social media and community engagement, to the web page.

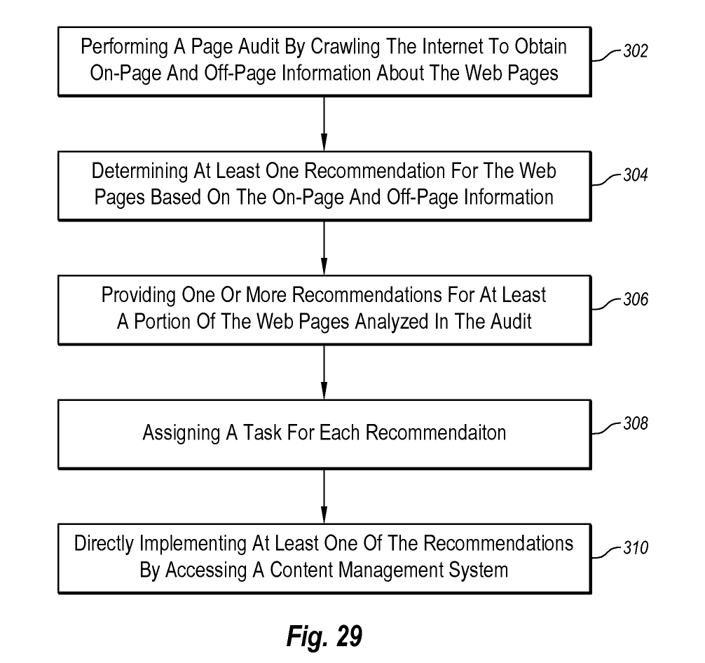

FIG. 29 illustrates a method of providing recommendations for optimizing web pages to improve rank for the web pages. The rank may include a position of a web page relative to other web pages within results of a search of one or more keywords using a search engine. The keywords may be selected by the user, for example. The user may select any number of keywords. One of the keywords may be assigned as a “primary” keyword based on keyword volume and all on-page factors may be based on that keyword. The other “secondary” keywords, or any other keywords paired to that page, will be given recommendations for off-page factors such as anchor text on links.

A first act 302 of the method 300 may include performing a page audit by crawling the Internet to obtain on-page and off-page information about the web pages. Users, such as an entity or customer, may define page audit rules specifying which of the web pages or page types will be audited. For example, the user may be provided with an interface, such as the user interface described with respect to FIGS. 15-26, which may include a setup screen that enables the user to define parameters for the audit. The parameters defined by the user will drive how pages are audited. The audit may be implemented, for example, by a system, such as the system described with respect to FIG. 1, that will use the parameters to perform the audit and detect issues associated with one or more of the web pages. As will be described, the system 100 may analyze data obtained from the audit and may generate recommendations based on this data.

For example, the audit may include a crawl of all web pages within a web site maintained by the entity. The audit may be performed by default on all the web pages that are already ranked for one or more keywords such that the web pages are automatically paired to the keywords or may be performed for a user-specified web page for that keyword. Accordingly, the audit of the web site may identify issues for the web pages within the web site determined to be most critical, such as those web pages with a keyword rank. The audit of the web site may be performed automatically for the web pages that are already ranked or for specified web pages within the web site. Optionally, the audit may include a crawl of a site map for the web site or additional web pages specified by the user.

The user may select the audit to include the ranked web pages, the specified web pages, a minimum number of web pages, a maximum number of web pages, or web pages within a site map, web site or domain, for example. As a non-limiting example, the user may provide a list of specific pages to web crawl and may set the maximum number of web pages to crawl, e.g., less than or equal to 15,000 web pages.

The method 300 may include a second act 304 of determining at least one recommendation for the web pages. The recommendations may be determined for each of the specified web pages, such as those within the web site, the page type, or user-defined pages. The recommendations may relate to on-page information, internal links, external links and social engagement.

If the recommendations are for the on-page data, the on-page data obtained in the audit may be analyzed to determine modifications to the on-page data to improve ranking for the keywords. The recommendations may relate to items within a template including content for one or more of the web pages. For example, the recommendations may relate to elements of the web pages, such as, page titles, heading elements (e.g., H1 tag, H2 tag, etc.), meta description, text describing an image for a search (e.g., image alt text), and keyword density. The data obtained from the web pages may be analyzed to determine if each of the elements of the web pages is present and, if not, the recommendation may be provided to add any missing elements, which may improve the web page ranking Additionally, the data obtained from the web pages may be analyzed to determine whether one or more of the keywords are present within the elements and, if not, the recommendation may include information for incorporating the keyword(s) into the elements to improve ranking In some embodiments, the recommendation may include a list of the elements in which the keywords may be incorporated, or may provide language for modifying the elements to include the keywords. In other embodiments, the recommendation may include a link or portal to a computing system that enables direct modification of the elements of the web pages, such as a content management system.

The elements of the web pages may be assigned priority and the recommendations may be provided based on the elements of highest priority. The data obtained from the web pages may be analyzed to determine if page title is present, includes the keywords and includes a desired format. The determination may include a first inquiry whether a selected keyword is the first word in the title, a second inquiry whether the selected keyword is used in the web page and a third inquiry whether each of the keywords are used in the page title. Additional inquiries may be related to a format of the page title, such as a length of the page title or duplicate page titles. While the inquiries are described with respect to the page title, a similar determination may be performed for each of the elements of the web page, such as the heading elements, the meta description, the image alt text, and the keyword density.

A third act 306 of the method 300 may include providing one or more recommendations for at least a portion of the web pages analyzed in the audit. The recommendations may be provided for all of the web pages, or alternatively, may be provided for a specified number of set of the web pages. As a non-limiting example, the recommendations may be provided for specified web pages, such as user-defined web pages, preferred landing pages (PLPs) and/or top ranked pages. For one or more of the elements in the web page, the recommendation may include a suggestion or a link to modify the web page to make target keyword the first word in the element, to use the target keyword in the element, to use each of the keywords in the element, to keep the target keyword and add the remaining keywords to the element, or to generate the element if the element is missing. Additionally, the recommendations may include a suggestion or link to modify the format of one or more of the elements of the web page.

As a non-limiting example, the user may be provided with the recommendations via an interface, such as the user interface described with respect to FIGS. 15-26. The interface may provide navigation buttons or links, such as those shown in FIG. 21 (View All, Optimize My Page, Fix Internal Links, Build External Links, Increase Social Engagement, and View Top 10 Ranking Pages).

Examples of recommendations that may be provided for one or more of the elements of the web page include, but are not limited to, the following: Missing or empty page title; Page title too short or too long; Duplicate Page Title; Meta title too short or too long; Missing or empty H1 tag; Missing or empty H2 tag; Maximum number of H1 tag; Maximum number of H2 tag; Missing meta description tag; Missing meta keyword tag; Image tags without Alt attributes; Image tags without Height and Width attribute; Poor text to code ratio; Bold tags; Italic tags; No Html4 or xhtml validation; Size greater than 500 KB; Page URL is too long; Canonical URL not in site map; and Duplicate Page Content. The recommendations may also be provided that enable increased engagement in social media. Examples of such recommendations are described in co-pending U.S. patent application Ser. No. 13/270,917, filed Oct. 11, 2011, entitled “Search Engine Optimization Recommendations Based on Social Signals,” co-pending U.S. patent application Ser. No. 13/476,893, filed May 21, 2012, entitled “Optimization of Social Media Engagement,” each of which is hereby incorporated by reference in its entirety.

Additional examples of recommendations related to keywords may include, but are not limited to, Target Keyword(s) not used in Page title; Target Keyword(s) not used in the H1 tag; Target Keyword(s) not used in the H2 tag; Target Keyword(s) not used in the meta description tag; Target Keyword(s) not used in alt text of image tag; and Target Keyword(s) not used in page URL.

Optionally, a fourth act 308 of the method 300 may include assigning a task for each recommendation. For example, the task may be assigned by the user for each on-page recommendation. The user may dismiss one or more of the recommendations which have been assigned as a task and the system will warn the user that the task for that recommendation has been assigned and will be rendered invalid. The task status will become “closed by system” and task history will indicate that task is invalid. The user may create a single task for multiple recommendations of the same type (e.g., shorten page title, use one of the keywords in the page title, etc.), all of the recommendations in the task may be grouped into a single page title task. When one of the recommendations is closed, the task history may be updated to reflect that the one recommendation within the task has been closed and that one or more of the recommendations remain incomplete or open. The closed recommendations will no longer be displayed to the user. When all of the recommendations within the single task have been closed, either by the system when a response to the recommendation is received or manually by the user, the task will be removed. The user may have the option to dismiss the recommendations assigned as the task and before the task is removed, the system will warn the user that the task has been created for the recommendations and that the task will be rendered as invalid. The task history may be updated to indicate that the dismissed recommendation has become an invalid task.

The web page URL and target keyword pairing may be set by the system described with respect to FIG. 1 and the system may modify the pairing periodically. For example, the pairing may be modified based on keyword ranking. However, the web page URL and target keyword pairing may be locked in when one or more recommendations related to a target keyword (e.g., use keyword in title, URL, H1, H2, meta description, image alt text, etc.) is assigned as a task by the user. When the web page URL and target keyword are “locked in,” the web page URL and target keyword will not be modified by the system, but may be manually changed by the user.

The recommendation has been assigned as a task (e.g., Use Keyword A, B & C in page title) and the user manually changes the target keyword for that page (e.g., to keyword H) the following week, after clicking the Save button to confirm the new keyword-page association, the system will display a warning to the user that there are existing tasks created using the original keyword-page assignment and those tasks will become invalid. The task history should indicate that that task is now invalid. If a keyword is deleted and that keyword is used in one of the tasks assigned, that task may be closed and the task history will be updated to reflect the invalid task. If a preferred landing page is deleted from a keyword or removed and that preferred landing page is assigned as a task, that task may be closed and the task history will be updated to indicate that the task is invalid.

The user may overwrite and customize the recommendations for any of the elements. For example, the user may define a desired page title, which may then be verified before closing out the recommendation.

A fifth act 310 of the method 300 may include directly implementing at least one of the recommendations by accessing a content management system. For example, a link or portal may be provided along with the recommendation such that a modification to the web pages based on the recommendation may be input and modification may be transmitted to the content management system such that the modification is made. The content management system may be used to directly modify or update an element of a page template for a web page of the plurality based on page performance data.

The method, thus, provides specific recommendations for users to improve rankings by optimizing specific on-page elements based on issues identified in independently in keyword-to-page pair and site audit. In addition, the users may manage the recommendations at a keyword level and may pair multiple keywords to one or more web pages. The method further enables the user to assign tasks at a page-level and to customize the web page to fit their needs based on the specific recommendations generated based on the analysis of their web pages.

Accordingly, methods and systems have been provided herein for optimizing search engine results for a particular page type. In at least one example, a method for search engine result optimization includes creating page types corresponding to groupings of websites with common keyword variants, subject matter or templates. Searches are then performed on various search engines using the identified page types as a basis for the searches. Based on the search results, the entity can then determine how a particular page is performing on search engines with respect to the various page types. This performance analysis may be in addition to the total number of web pages the entity has indexed on various search engines. In the case of analyzing performance based on several meaningful page types, a change in actions related to the entity can be more readily understood since changes can be isolated to page types rather than to aggregate references to the entire entity. Such an approach can provide a useful degree of granularity since each page type represents a meaningful category of data. Further, such an approach can help surface how page types are trending as well as help identify categories for investigation.

For example, a page type associated a specific design template can be watched in order to identify any errors which are common to all the pages of a particular design template. Alternatively, the data may be analyzed to determine a type of link which would be useful for all the pages of a particular page type.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method for optimizing search results related to an entity:
categorizing a plurality of web pages into a plurality of page types;
performing a search of a network according to a set of specified criteria in order to obtain business performance data for each of the page types; and
analyzing the business performance data to determine how to optimize the performance of a particular page type.

2. The method of claim 1, wherein obtaining business performance data comprises calculating an amount of time spent on the plurality of the web page of the page type, a number of page views of the web page of the page type, a number of sales resulting from visits to the web page of the page type, a number of backlinks which refer to the web page of the page type, and/or a number of social media objects which refer to the web page of the page type.

3. The method of claim 2, further comprising displaying the business data to a user.

4. The method of claim 3, wherein the business performance data is analyzed for each web page of a particular page type and wherein the business data for a particular page type is displayed along with the business data for each web page of the particular page type.

5. The method of claim 2, wherein analyzing the business performance data comprises calculating a score based on the calculated amount spent on the plurality of the web pages of the page type, the number of page views of the web pages of the page type, the number of sales resulting from visits to the web pages of the page type, the number of backlinks which refer to the web pages of the page type, and/or the number of social media objects which refer to the web pages of the page type.

6. The method of claim 1, wherein categorizing a plurality of web pages into a plurality of page types comprises categorizing a plurality of web pages of a particular template into a page type.

7. The method of claim 6, wherein analyzing the business performance data comprises identifying a value of the particular template.

8. The method of claim 6, wherein analyzing business performance data for each of the page types comprises identifying any system errors for the particular template.

9. The method of claim 8, further comprising remedying any system errors of the particular template which have been identified.

10. A method of page reporting, comprising:
tracking a plurality of web pages of an entity to determine references to each web page of the plurality, the references comprising at least one of internal links and external references;
evaluating the external references to each of the web pages of the plurality to determine a ranking for each of the web pages based on at least one keyword;
determining at least one recommendation for improving the ranking for each of the web pages based on at least one keyword;
providing the at least one recommendation via a user interface;
receiving instructions for at least one change to the web page or a template of the web page at the user interface; and
directly implementing the at least one change to the web page by accessing a content management system.

11. The method of claim 10, wherein evaluating the external references to each web page of the plurality to determine a ranking comprises determining at least one of a position in a search result by searching specific keyword on a search engine, an aggregate search volume of all keywords or search volume of a top ranking keyword, and an average cost-per-click value of the at least one keyword.

12. The method of claim 10, wherein determining at least one recommendation comprises identifying a content management system error for a page template for a web page of the plurality based on page performance data.

13. The method of claim 10, wherein determining at least one recommendation comprises generating recommendations according to page type, the page type including the web pages of the plurality having a common template or term within a URL.

14. The method of claim 13, wherein generating recommendations according to page type comprises recommending reformatting the template of the web pages of the page type.

15. The method of claim 10, wherein providing the at least one recommendation comprises providing at least one recommendation based on revenue, traffic visits, search volume or page authority.

16. The method of claim 10, wherein determining at least one recommendation comprises detecting the internal links pointing to a given page URL and identifying improvements to the internal links.

17. The method of claim 16, wherein the internal links each comprise other web pages from the same domain as the web pages.

18. The method of claim 10, wherein tracking a plurality of web pages of an entity comprises tracking the plurality of web pages having different URL formats for different user devices.

19. The method of claim 18, wherein the different URL formats may be for at least one of a mobile device, a tablet, a mobile kiosk, a smartphone and a personal digital assistant.

20. A method for optimizing search results related to an entity, comprising:
grouping a plurality of web pages to define a page type, each of the plurality of web pages in the page type including at least one identifier of the page type;
identifying at least one error in a template for the plurality of web pages in the page type, the at least one error related to a ranking of at least one of the web pages of the plurality; and
providing a recommendation for modifying the template to improve the ranking

21. The method of claim 20, further comprising automatically accessing a content management system to modify the template in response to a change to the template input by a user.

22. The method of claim 20, wherein identifying at least one error in a template for the plurality of web pages in the page type comprises crawling the Internet to obtain data related to external references and to identify elements within each of the plurality of webpages.

23. The method of claim 20, wherein providing at least one recommendation for modifying the template comprises providing the at least one recommendation for modifying at least one of a URL, a meta description, and a page title contained in the template.

24. The method of claim 20, wherein providing at least one recommendation for modifying the template comprises providing recommendations for each of the plurality of web pages in the page type in order of relevance, the relevance determined based on a ranking of each of the plurality of web pages in a search result rendered by keyword on a search engine.

25. A method for optimizing search results related to an entity, comprising:
tracking a plurality of web pages of an entity to determine references to the plurality of web pages;
evaluating the external references to each of the web pages of the plurality to determine a ranking for each of the web pages based on at least one keyword;
generating at least one recommendation for improving the ranking for each of the web pages based on content; and
directly accessing a content management system to modify the content displayed on at least one of the web pages.

26. The method of claim 25, wherein the content comprises at least one of an image file, a video file and an audio file.

27. The method of claim 25, wherein tracking a plurality of web pages of an entity to determine references to the plurality of web pages comprises determining internal links and external references to the plurality of web pages.

28. The method of claim 25, wherein generating at least one recommendation for improving the ranking for each of the web pages based on content comprises identifying high authority websites and providing a request for backlinks to point to at least one of the web pages from at least one of the high authority websites.

29. The method of claim 25, wherein generating at least one recommendation comprises generating the at least one recommendation to drive customer engagement based one or more trends identified for the web page.

30. The method of claim 29, wherein the one or more trends comprises a web page ranking highly for at least one keyword during a specified period of time.
